(19) United States
(12) Patent Application Publication
(10) Pub. No.: US 2017/0072683 A1
(43) Pub. Date: Mar. 16, 2017

(54) DROPLET EJECTION METHOD, DROPLET EJECTION PROGRAM, AND DROPLET EJECTION APPARATUS

(71) Applicant: SEIKO EPSON CORPORATION, Tokyo (JP)

(72) Inventor: Hirofumi SAKAI, Shiojiri-shi (JP)

(73) Assignee: SEIKO EPSON CORPORATION, Tokyo (JP)

(21) Appl. No.: 15/261,211

(22) Filed: Sep. 9, 2016

(30) Foreign Application Priority Data
Sep. 16, 2015 (JP) 2015-182622

(51) Int. Cl. B41J 2/045

(52) U.S. Cl. CPC B41J 2/04535; B41J 2/04586

(57) ABSTRACT

A droplet ejection method includes: changing the drive condition in at least one of multiple ejections so as to correct the difference between a predetermined liquid amount and the total ejection amount of the liquid ejected in the form of a droplet by driving the nozzle under a preset drive condition; and driving at least one of the nozzles under the new drive condition to redetermine the total ejection amount of liquid of when performing multiple ejections.

### BACKGROUND

1. Technical Field

The present invention relates to a droplet ejection method, a droplet ejection program, and a droplet ejection apparatus.

2. Related Art

An inkjet method (or a droplet ejection method as it is also called) is known in which a liquid containing functional materials is ejected onto a placement region of an ejection target, for example, such as a substrate in the form of a droplet through a plurality of nozzles of an inkjet head, and dried (solidified) to form a thin film in the placement region. Typical examples of such a thin film include thin films used for thin display devices, such as color filters of liquid crystal display panels, and light-emitting layers of organic EL panels, and semiconductor layers and metal wiring of semiconductor devices.

The inkjet method requires accurately ejecting a predetermined amount of liquid in a placement region, and drying the liquid to forma thin film of the desired thickness. Because the amounts of droplets ejected through a plurality of nozzles of an inkjet head are not always constant but have variation, it has been proposed to reduce the variation of ejection amounts across the nozzles with ingenuity.

For example, JP-A-2008-276088 proposes a drive signal setting method that includes the step A of sorting a plurality of nozzles into a plurality of groups according to the ejection amount of when a drive element provided for each nozzle is driven with a drive signal of predetermined conditions; the step B of calculating optimum conditions for a drive signal corresponding to each group using a statistical value of an ejection amount concerning the group; and the step C of selecting a condition from the optimum conditions of the drive signals corresponding to the plurality of groups, and setting the selected condition for each nozzle. It is stated in this publication that the variation of ejection amounts across nozzles can be reduced by the selection of an appropriate drive signal according to the nozzle characteristics, even with the limited numbers of drive signal setting conditions.

Another example is JP-A-2015-33657, which proposes an inkjet printing method in which the difference between (i) the pixel average total volume obtained by multiplying certain numbers of landed droplets with the average ejection amount of single droplets through a nozzle obtained beforehand with respect to some of or all of a plurality of nozzles, and (ii) the pixel landing total volume of droplets landed at selected positions of a pixel region is confined within a certain range in landing certain numbers of droplets in each pixel region of a substrate. In this related art, the nozzle that actually ejects a droplet is selected according to the average ejection amount of each nozzle so that the difference between the pixel average total volume and the pixel landing total volume becomes small in a landing position pattern representing nozzles that can eject droplets to a pixel region, and the number of ejections (ejection timing) through the nozzles. In other words, a nozzle is selected from a plurality of ejectable nozzles to mitigate the adverse effect of ejection amount variation across the nozzles.

However, in JP-A-2015-33657, the number of nozzles in a plurality of nozzles capable of ejecting droplets with respect to the pixel region representing a placement region needs to be greater than the number of nozzles that actually eject droplets, and the alleged effect of the invention cannot be sufficiently exhibited unless there are sufficient numbers of selectable nozzles. For example, the invention of this related art is not applicable when only one nozzle is selectable for the placement region.

A problem also occurs when an appropriate drive signal is selected from a plurality of drive signals, and set for groups of nozzles as in JP-A-2008-276088. Specifically, the effect to correct the total ejection amount of ejected droplets in a placement region with the selected drive signal becomes smaller, and it becomes difficult to control the total ejection amount with high accuracy when ejecting multiple droplets in a placement region through the nozzles.

### SUMMARY

An advantage of some aspects of the invention is to solve at least a part of the problems described above, and the invention can be implemented as the following forms or application examples.

### Application Example

A droplet ejection method according to an application example of the invention is a method in which an ejection head having a plurality of nozzles, and an ejection target are disposed face to face, and moved relative to each other for scanning, and in which a liquid is ejected multiple times in the form of a droplet through at least one of the plurality of nozzles to a placement region provided on the ejection target, the method including: step A of driving the at least one nozzle under a preset drive condition, and determining the total ejection amount of the liquid of when performing the multiple ejections; step B of determining the difference between the total ejection amount, and a predetermined amount of the liquid to be placed in the placement region; step C of changing the drive condition for at least one of the multiple ejections so as to correct the difference between the predetermined amount of the liquid and the total ejection amount; and step D of driving the at least one nozzle under the drive condition changed in the step C, and redetermining the total ejection amount of the liquid of when performing the multiple ejections.

According to this application example, the drive condition is changed in at least one of the multiple ejections, and the difference between the design predetermined amount of the liquid to be placed in the placement region, and the total ejection amount of liquid determined in step A can be corrected. For example, the droplet ejection method enables correction that brings the total ejection amount of the ejected liquid closer to the design predetermined amount, for example, even when a plurality of droplets is ejected to the placement region through a single nozzle.

It is preferable that the droplet ejection method of the application example further includes step E of repeating the steps C, D, and B in this order until the difference between the predetermined amount of the liquid and the total ejection amount becomes smaller than a correction resolution for the correction of droplet ejection amount by a change of the drive condition.

According to this method, the total ejection amount of liquid can be corrected within the range of the correction resolution for the correction of droplet ejection amount.

In the droplet ejection method of the application example, the method may set a maximum correction amount for the correction of droplet ejection amount by a change of the drive condition, and the method in the step C may change the drive condition for two or more of the multiple ejections when the difference between the predetermined amount of the liquid and the total ejection amount exceeds the maximum correction amount.

According to this method, the drive condition is changed at least two times, and the drive condition can be changed without putting an excessive load on the drive element used to eject a droplet through the nozzle, as compared to when the total ejection amount of liquid is corrected by changing the drive condition in one of the multiple ejections. In other words, it is possible to prevent unexpectedly large variation in the droplet ejection amount as might occur when droplets are ejected through a nozzle that is under the excessive load produced as a result of changing the drive condition of the drive element.

In the droplet ejection method of the application example, it is preferable that the method in the step C changes the drive condition in at least one of the multiple ejections in a direction from the last ejection to the first ejection.

In changing the drive condition of the nozzle in any of the ejections of continuously ejected droplets through the nozzle, the change may influence the droplet ejection amount when the nozzle is driven under the preset drive condition in the next ejection. However, because the method changes the drive condition of the nozzle from the last ejection, variation in the ejection amounts of droplets following a change of the drive condition can be reduced.

In the droplet ejection method of the application example, the corrected value of the droplet ejection amount related to the change made in the step C to the drive condition of the last ejection of the multiple ejections may be larger than the corrected value of the droplet ejection amount related to the change in the drive condition of any other ejection.

According to this method, variation of ejection amounts following a change of the drive condition can be reduced compared to when, for example, the drive condition is changed to produce a largest value for the correction of the droplet ejection amount in the second last ejection.

In the droplet ejection method of the application example, the method in the step A may perform the multiple ejections by driving the at least one nozzle under a preset drive condition, and measures and determines the total ejection amount of the ejected liquid.

According to this method, the drive condition can be accurately changed to correct the total ejection amount according to the measured value of the total ejection amount of the liquid.

In the droplet ejection method of the application example, the method in the step D may perform the multiple ejections by driving the at least one nozzle under the drive condition changed in the step C, and measures and determines the total ejection amount of the ejected liquid.

According to this method, the total ejection amount of liquid is measured after changing the drive condition, and the method can confirm whether the change made to the drive condition was appropriate.

In the droplet ejection method of the application example, the ejection head may have a drive element for each of the plurality of nozzles, and may vary the droplet ejection amount by varying a drive voltage applied to the drive element, and the method in the step D may drive the at least one nozzle under the drive condition changed in the step C, using ejection amount information indicative of the relationship between the drive voltage of each drive element and droplet ejection amounts, and may calculate and determine the total ejection amount of the liquid of when the multiple ejections are performed.

According to this method, the drive condition can be changed, and the total ejection amount can be corrected more easily than when the drive condition is changed by changing parameters, for example, such as frequency, in addition to the drive voltage.

In the droplet ejection method of the application example, the placement region provided on the ejection target may be substantially rectangular in shape with the longitudinal direction extending in a scan direction, and the plurality of nozzles of the ejection head may be arranged in a direction intersecting the scan direction.

According to this method, the relative positional relationship between the ejection head and the placement region takes the form of the positional relationship of so-called longitudinal drawing, and the total ejection amount of liquid can be corrected to approach the predetermined amount by changing the drive condition, and varying the ejection amount of the droplet ejected through a single nozzle, even when only a single nozzle covers the placement region in a scan.

### Application Example

A droplet ejection program according to an application example of the invention is a program for causing a computer to execute the droplet ejection method of the application example, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

According to the application example, the drive condition is changed in at least one of the multiple ejections, and the difference between the design predetermined amount of the liquid to be placed in the placement region, and the total ejection amount of liquid determined in step A is corrected. For example, the droplet ejection program enables correction that brings the total ejection amount of the ejected liquid closer to the design predetermined amount, even when, for example, a plurality of droplets is ejected to the placement region through a single nozzle.

### Application Example

A droplet ejection apparatus according to an application example of the invention is an apparatus in which an ejection head having a plurality of nozzles, and an ejection target are disposed face to face, and moved relative to each other for scanning, and in which a predetermined amount of liquid is ejected multiple times in the form of a droplet through at least one of the plurality of nozzles to a placement region provided on the ejection target, the droplet ejection apparatus including: a stage on which the ejection target is mounted; a moving mechanism for moving the stage in a first direction, relative to the ejection head; a head driving section for driving a drive element provided for each of the plurality of nozzles of the ejection head; an ejection amount measuring mechanism for measuring a total ejection amount of the liquid ejected through the ejection head; a first memory section in which information of a drive condition for driving the drive element is stored; a second memory section in which a measured value of the total ejection amount of the liquid is stored; and a control section, wherein the control section drives and controls the head driving section and the ejection amount measuring mechanism, and the moving mechanism so as to execute: step A of performing the multiple ejections by driving the at least one nozzle under a drive condition prestored in the first memory section, and determine the total ejection amount of the ejected liquid with the ejection amount measuring mechanism; step B of determining the difference between the predetermined amount of the liquid, and the total ejection amount; step C of changing the drive condition for at least one of the multiple ejections so as to correct the difference between the predetermined amount of the liquid and the total ejection amount, and store the drive condition in the first memory section; step D of driving the at least one nozzle under the drive condition changed, and redetermine the total ejection amount of the liquid of when performing the multiple ejections; step E of repeating the steps C, D, and B in this order until the difference between the predetermined amount of the liquid and the total ejection amount becomes smaller than a correction resolution for the correction of droplet ejection amount by a change of the drive condition; and step F of moving and scanning the ejection head and the ejection target in the first direction with the moving mechanism, and eject the liquid in the predetermined amount multiple times in the form of a droplet through at least one of the plurality of nozzles to the placement region provided on the ejection target, using the currently changed drive condition.

According to the application example, the drive condition is changed in at least one of the multiple ejections, and the difference between the design predetermined amount of the liquid to be placed in the placement region, and the total ejection amount of liquid determined in step A is corrected. For example, the droplet ejection apparatus enables correction that brings the total ejection amount of the ejected liquid closer to the design predetermined amount, even when, for example, a plurality of droplets is ejected to land on the placement region through a single nozzle.

In the droplet ejection apparatus of the application example, the placement region provided on the ejection target may be substantially rectangular in shape, and the ejection target may be mounted on the stage in such an orientation that the longitudinal direction of the placement region is aligned with the first direction, and the plurality of nozzles of the ejection head may be arranged in a direction intersecting the first direction.

According to this configuration, the relative positional relationship between the ejection head and the placement region takes the form of the positional relationship of so-called longitudinal drawing, and the total ejection amount of liquid can be corrected to approach the predetermined amount by changing the drive condition, and varying the ejection amount of the droplet ejected through a single nozzle, even when only a single nozzle covers the placement region in a scan.

### BRIEF DESCRIPTION OF THE DRAWINGS

The invention will be described with reference to the accompanying drawings, wherein like numbers reference like elements.

FIG. 1 is a schematic perspective view illustrating a configuration of a droplet ejection apparatus.

FIG. 2 is a schematic perspective view illustrating a configuration of an inkjet head.

FIG. 3 is a plan view representing the placement of a plurality of nozzles on the nozzle face of the inkjet head.

FIG. 4 is a schematic plan view representing the arrangement of inkjet heads in a head unit.

FIG. 5 is a block diagram representing the electrical and mechanical configuration of the droplet ejection apparatus.

FIG. 6 is a block diagram representing the electrical control of the inkjet head.

FIG. 7 is a timing chart of drive signals and control signals.

FIG. 8 is a schematic plan view illustrating a configuration of an organic EL device.

FIG. 9 is a schematic cross sectional view illustrating the configuration of an organic EL element.

FIG. 10 is a schematic cross sectional view representing an organic EL element producing method.

FIG. 11 is a schematic cross sectional view representing the organic EL element producing method.

FIG. 12 is a schematic cross sectional view representing the organic EL element producing method.

FIG. 13 is a schematic plan view representing an example of the placement of droplets in an aperture.

FIG. 14 is a flowchart representing a droplet ejection method.

FIG. 15 is a schematic plan view representing an example of ejections with a corrected ejection amount of droplet in multiple ejections.

FIG. 16 is a schematic plan view representing another example of ejections with a corrected ejection amount of droplet in multiple ejections.

FIG. 17 is a table representing the correction of droplet ejection amounts, and the drive voltages of drive signals applied to the piezoelectric element according to Examples.

FIG. 18 is a graph representing volume variation of the total ejection amount obtained after the correction of droplet ejection amounts according to Examples.

FIG. 19 is a schematic plan view representing a droplet ejection method of a variation.

### DESCRIPTION OF EXEMPLARY EMBODIMENTS

Specific embodiments of the invention are described below with reference to the accompanying drawings. Note that the components, members, or features shown in the drawings are enlarged or reduced as appropriate to make them recognizable for the sake of explanation.

### Droplet Ejection Apparatus

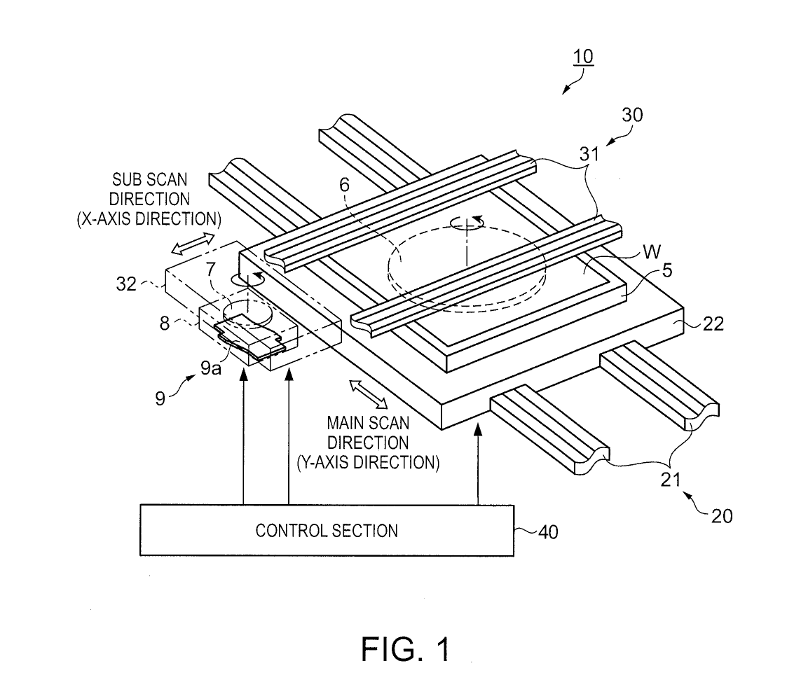

The following will describe an example of a droplet ejection apparatus to which a droplet ejection method of an embodiment of the invention is applicable, with reference to FIGS. 1 to 5. FIG. 1 is a schematic perspective view illustrating a configuration of a droplet ejection apparatus of an embodiment of the invention. The droplet ejection apparatus 10 illustrated in FIG. 1 is an apparatus that ejects a functional material-containing liquid in the form of a droplet onto an ejection target (work) through nozzles of an ejection head. The ejected liquid is solidified by being dried and burned, and a functional layer is formed in a placement region of the ejection target. A method that forms a functional layer in this fashion is a liquid phase process called a droplet ejection method. An example of the functional layer formed by using a droplet ejection method is a layer with a light-emitting function in an organic EL element, as will be described later. The droplet ejection method of the present embodiment can preferably be used to form such a functional layer with the droplet ejection apparatus 10. The droplet ejection apparatus 10 uses an inkjet head as the ejection head, and a droplet ejection method that uses an inkjet head is also called an inkjet method.

As illustrated in FIG. 1, the droplet ejection apparatus 10 includes a work moving mechanism 20 and a head moving mechanism 30. The work moving mechanism 20 is provided to move an ejection target (work), for example, a plate-shaped substrate W, in a main scan direction (first direction). The head moving mechanism 30 is provided to move an inkjet head-mounted head unit 9 in a sub scan direction that is orthogonal to the main scan direction. The droplet ejection apparatus 10 also includes a control section 40 for overall control of these mechanisms (configurations), and other mechanisms (configurations) not illustrated in FIG. 1. In the following descriptions, the main scan direction and the sub scan direction also will be referred to as Y-axis direction and X-axis direction, respectively.

The work moving mechanism 20 includes a pair of guide rails 21, a movable table 22 that is moved along the pair of guide rails 21, and a stage 5 disposed on the movable table 22 via a rotation mechanism 6, and on which the substrate W is mounted.

The stage 5 is adapted to fix the substrate W by suction, and to accurately align the reference axis in the substrate W with the main scan direction (Y-axis direction) and the sub scan direction (X-axis direction) with the rotation mechanism 6.

The substrate W can be rotated, for example, 90 degrees, according to the placement of the placement region on the substrate W to which the liquid (ink) is ejected.

The head moving mechanism 30 includes a pair of guide rails 31, and a movable table 32 that is moved along the pair of guide rails 31. The movable table 32 is provided with a carriage 8 suspended via the rotation mechanism 7.

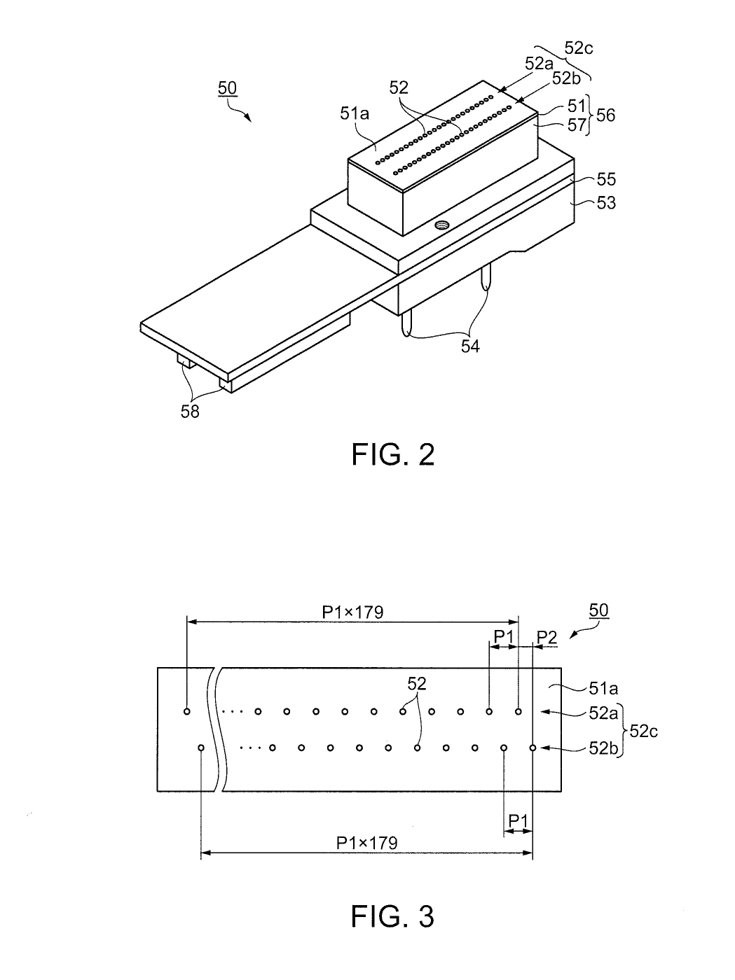

On the carriage 8 is installed a head unit 9 that includes inkjet heads 50 (see FIG. 2) mounted as ejection heads on a head plate 9a.

The movable table 32 moves the carriage 8 in sub scan direction (X-axis direction), and the head unit 9 is disposed opposite the substrate W.

In addition to the configuration described above, the droplet ejection apparatus 10 is configured to include other components, including an ink supply mechanism for supplying liquid (ink) to the inkjet heads 50 mounted on the head unit 9, and a maintenance mechanism provided for maintenance of the inkjet heads 50.

FIG. 2 is a schematic perspective view illustrating a configuration of one of the inkjet heads. FIG. 3 is a plan view representing the placement of a plurality of nozzles on the nozzle face of the inkjet head.

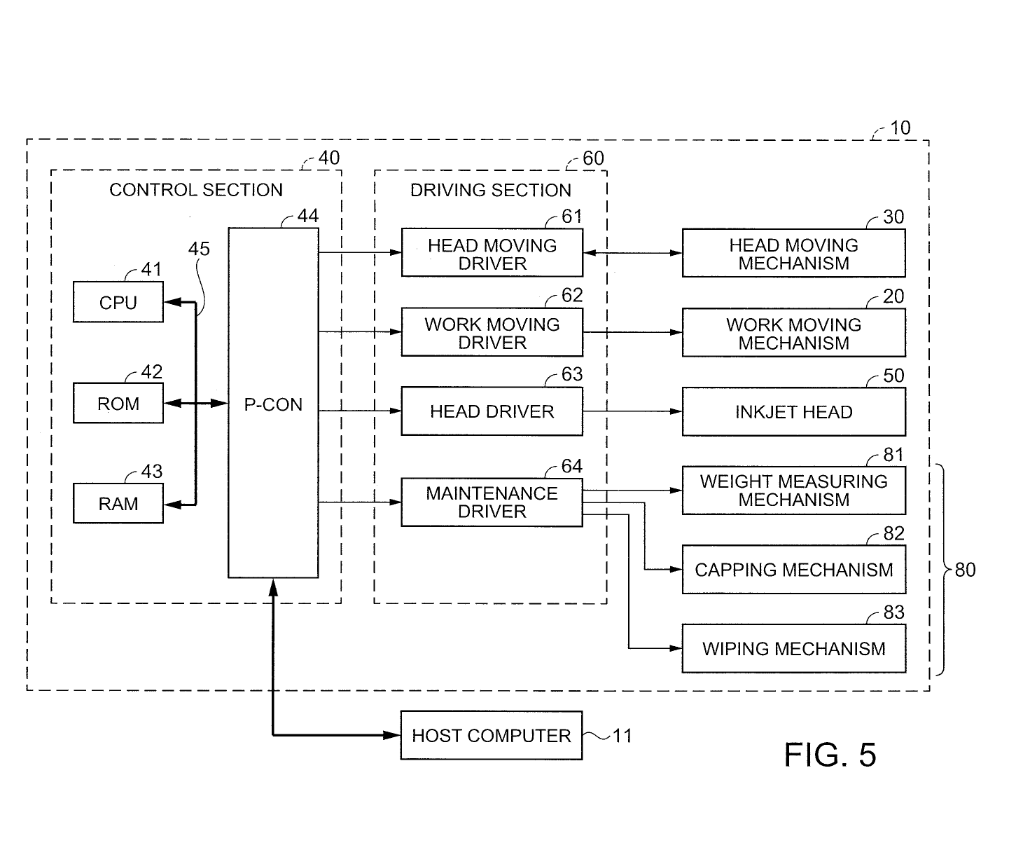

As illustrated in FIG. 2, the inkjet head 50 is a so-called duplex head, and includes a liquid (ink) inlet portion 53 having a dual connection needle 54, a head substrate 55 laminated on the inlet portion 53, and a head main body 56 disposed on the head substrate 55 and in which head channels are formed for the liquid (ink). The connection needles 54 are connected to the ink supply mechanism (not illustrated) via pipes, and supply the liquid (ink) to the head channels. The head substrate 55 is provided with a dual connector 58 connected to a head driver 63 (head driving section, see FIG. 5) via a flexible flat cable (not illustrated).

The head main body 56 includes a pressurizer 57 and a nozzle plate 51. The pressurizer 57 has a cavity configured from a piezoelectric element provided as a drive element (actuator). The nozzle plate 51 has a nozzle face 51a in which two nozzle lines 52a and 52b are formed parallel to each other.

As illustrated in FIG. 3, the two nozzle lines 52a and 52b each have a plurality of (for example, 180) nozzles 52 that are arranged at substantially regular intervals with pitch P1, and the nozzles 52 of each line are arranged on the nozzle face 51a by being offset from the other line by pitch P2, a half the distance of pitch P1. In the present embodiment, the pitch P1 is, for example, about 141 μm. This is to say that 360 nozzles 52 are arranged at a nozzle pitch of about 70.5 μm as viewed from a direction orthogonal to the nozzle line 52c configured from the two nozzle lines 52a and 52b. Each nozzle 52 has a diameter of about 27 μm. In the following, the two nozzle lines 52a and 52b configured from a plurality of nozzles 52 will be referred to as nozzle line 52c for the sake of explanation.

In response to a drive signal applied as an electrical signal from the head driver 63 to the piezoelectric element in the inkjet head 50, volume fluctuations occur in the cavity of the pressurizer 57. The resulting pumping action pressurizes the liquid (ink) filling the cavity, and causes the liquid (ink) to discharge as a droplet through the nozzles 52.

The drive element (actuator) provided for each nozzle 52 in the inkjet head 50 is not limited to the piezoelectric element. The actuator may be an electromechanical transducer that causes a displacement in a vibration plate by electrostatic adsorption, or a thermoelectric transducer that heats the liquid (ink), and causes it to discharge through the nozzles 52.

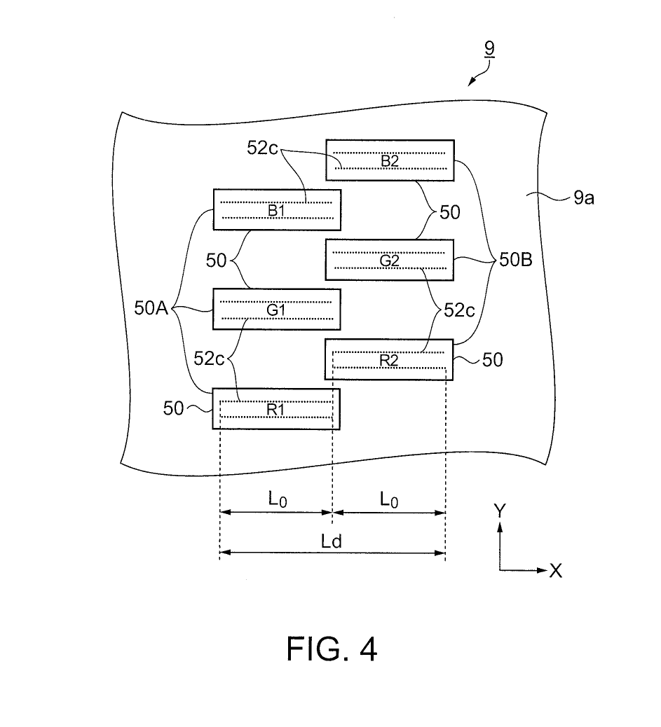

FIG. 4 is a schematic plan view representing the arrangement of the inkjet heads in the head unit, specifically as viewed from the side opposite the substrate W.

As illustrated in FIG. 4, the head unit 9 includes the head plate 9a with a plurality of inkjet heads 50 disposed thereon. On the head plate 9a are mounted a total of six inkjet heads 50 including a head group 50A of three inkjet heads 50, and a head group 50B of three inkjet heads 50. In the present embodiment, the head R1 (inkjet head 50) of the head group 50A, and the head R2 (inkjet head 50) of the head group 50B eject the same liquid (ink). The same is the case for the head G1 and the head G2, and for the head B1 and the head B2. Specifically, the head unit 9 is configured to enable ejection of three different liquids (inks).

The draw width that can be covered by a single inkjet head 50 is L₀, and this is defined as the effective length of the nozzle line 52c. The nozzle line 52c is configured from 360 nozzles 52.

The head R1 and the head R2 are disposed side by side in main scan direction so that the adjacent nozzle lines 52c relative to the main scan direction (Y-axis direction) are continuous to each other after a single nozzle pitch in the sub scan direction (X-axis direction) orthogonal to the main scan direction. Accordingly, the effective draw length Ld of the head R1 and the head R2 ejecting the same liquid (ink) is twice as long as the draw width L₀. The head G1 and the head G2, and the head B1 and the head B2 are also disposed side by side in the main scan direction (Y-axis direction).

The nozzle lines 52c provided in the inkjet head 50 are not limited to a duplex, and may be a single line. The arrangement of the inkjet heads 50 in the head unit 9 is also not limited to the example described above.

The droplet ejection apparatus 10 is described below with regard to the electrical and mechanical configurations, and the functions, with reference to FIG. 5. FIG. 5 is a block diagram representing the electrical and mechanical configuration of the droplet ejection apparatus 10.

As shown in FIG. 5, the droplet ejection apparatus 10 includes a driving section 60 and the control section 40. The driving section 60 has various drivers for driving components such as the head moving mechanism 30, the work moving mechanism 20, the inkjet heads 50, and the maintenance mechanism 80. The control section 40 is provided for overall control of the droplet ejection apparatus 10, including the driving section 60.

The driving section 60 includes a head moving driver 61 for driving and controlling the linear motor of the head moving mechanism 30, a work moving driver 62 for driving and controlling the linear motor of the work moving mechanism 20, a head driver 63 (head driving section) for driving and controlling the inkjet heads 50, and a maintenance driver 64 for driving and controlling the maintenance mechanism 80.

The droplet ejection apparatus 10 also includes a linear scale and a scale head capable of detecting the main scan direction (Y-axis direction) position of the movable table 22 in the work moving mechanism 20, and an encoder corresponding to the scale head, though not shown in FIG. 5. Similarly, the head moving mechanism 30 includes a linear scale and a scale head capable of detecting the sub scan direction (X-axis direction) position of the movable table 32, and an encoder corresponding to the scale head. The movement of the movable table 22, and the movement of the movable table 32 are controlled by using encoder pulses periodically generated by these encoders.

The maintenance mechanism 80 is configured to include a weight measuring mechanism 81 including, for example, an electronic balance, that receives and weighs the test droplet ejected through the nozzle 52 of the inkjet head 50; a capping mechanism 82 that seals the nozzle face 51a (see FIG. 2) of the inkjet head 50, and recovers a clogged nozzle 52 by sucking the liquid (ink) out of the nozzle 52; and a wiping mechanism 83 that cleans the nozzle face 51a by wiping foreign objects adhering to the nozzle face 51a, using a wiping member.

The maintenance driver 64 is configured to include drivers for driving the mechanisms used for maintenance of the inkjet heads 50. The maintenance mechanism 80 is not limited to the configuration described above, and may include other mechanisms, such as an imaging mechanism that detects, for example, the spot position accuracy of a droplet, or clogging by imaging the landed state of a droplet after the ejected droplet has landed on an object such as a sheet through the nozzle 52 of the inkjet head 50. The weight measuring mechanism 81 is an example of the ejection amount measuring mechanism of the droplet ejection apparatus according to the invention. A mechanism that determines the volume of a droplet by measuring its size after imaging the landed state of the droplet with the imaging mechanism may also represent the ejection amount measuring mechanism according to the invention.

The control section 40 includes a CPU 41, a ROM 42, a RAM 43, and a P-CON (program controller) 44, which are connected to one another via a bus 45. The P-CON 44 is connected to a host computer 11. The ROM 42 has a control program region that stores control programs or other information processed by the CPU 41, and a control data region that stores control data and other such information used to perform various processes, including a drawing operation, and a maintenance process for recovering the functions of the inkjet heads 50.

The RAM 43 is used as memory with various work regions for control processes, and has various memory sections, including an ejection position data memory section that stores ejection position data indicative of how droplets should be ejected and placed with respect to the substrate W, and a position data memory section that stores position data of the substrate W and the inkjet heads 50 (nozzle line 52c, to be more exact). The various drivers of the driving section 60 are connected to the P-CON 44, among other components. The P-CON 44 is configured to include a logic circuit that is incorporated to complement the functions of the CPU 41, and to handle interface signals for peripheral circuits. For this purpose, the P-CON 44 fetches various commands from the host computer 11 into the bus 45 either directly or after a process, and, by working with the CPU 41, outputs to the driving section 60 the output data and control signals sent by the CPU 41 or other members to the bus 45, either directly or after a process. The RAM 43 of the present embodiment is an example of the second memory section according to the invention, and the CPU 41 or the host computer 11 is an example of the computer for executing the droplet ejection program according to the invention.

Under the instructions of the control program in the ROM 42, the CPU 41 inputs various detection signals, commands, data, and other such information via the P-CON 44, and, after processing the data and other information in the RAM 43, outputs various control signals to the driving section 60 and other members via the P-CON 44 to control the overall operation of the droplet ejection apparatus 10. For example, the CPU 41 controls the inkjet heads 50, the work moving mechanism 20, and the head moving mechanism 30 to dispose the head unit 9 and the substrate W face to face. In synchronism with the relative movement of the head unit 9 and the substrate W (stage 5), the CPU 41 sends a control signal to the head driver 63 so that the liquid (ink) is ejected in the form of a droplet onto the substrate W through the nozzles 52 of each inkjet head 50 installed in the head unit 9. In the present embodiment, ejection of the liquid (ink) in synchronism with the movement of the substrate W in Y-axis direction is called main scan, and the movement of the head unit 9 in X-axis direction relative to the main scan is called sub scan. The droplet ejection apparatus 10 of the present embodiment repeats the main scan and the sub scan multiple times in combination for the ejection of the liquid (ink) to the substrate W. The main scan is not limited to the unidirectional movement of the substrate W with respect to the inkjet heads 50, and may be performed by moving the substrate W in a reciprocating fashion.

The encoder provided in the work moving mechanism 20 generates an encoder pulse along with the main scan. The encoder pulse is periodically generated because the main scan moves the movable table 22 at a predetermined rate of movement.

The ejection resolution of droplets in main scan direction can be obtained by dividing the rate of movement by drive frequency. Specifically, for example, the ejection resolution becomes 10 μm when the rate of movement of the movable table 22 in a main scan is 200 mm/sec, and the drive frequency of driving the inkjet heads 50 (in other words, the ejection timing of continuously ejecting droplets) is 20 kHz. In other words, droplets can be placed on the substrate W at a pitch of 10 μm. Droplets can be placed on the substrate W at a pitch of 1 μm when the rate of movement of the movable table 22 is 20 mm/sec. The actual ejection timing of droplets is based on the ejection control data that is generated by counting the periodically generated encoder pulse. The term ejection resolution refers to the minimum placement pitch of droplets on the substrate W in a main scan.

The host computer 11 sends control information such as control programs, and control data to the droplet ejection apparatus 10. The host computer 11 also has a function as a placement information generator that generates placement information as ejection control data used for the placement of liquid (ink) droplets on the substrate W. The placement information is, for example, a bit map representation of information such as ejection position data indicative of a droplet placement position on the substrate W, ejection data indicative of the number of droplet placements (in other words, the number of ejections per nozzle 52), and ON/OFF (select/non-select) of a plurality of nozzles 52 in a main scan. The host computer 11 is not limited to generating the placement information, and may modify the placement information temporarily stored in the RAM 43.

The ejection position data indicative of a droplet placement position on the substrate W indicates the relative position of the substrate W and the nozzle 52 in a main scan. As described above, the substrate W is mounted on the stage 5, and moved with the movable table 22 in main scan direction (Y-axis direction). The main scan direction position of the substrate W, specifically the main scan direction position of the stage 5 is controlled by counting the encoder pulse periodically output from the encoder of the work moving mechanism 20 in a main scan. The sub scan direction (X-axis direction) position of the inkjet head 50, specifically the nozzles 52, with respect to the substrate W is controlled by counting the encoder pulse periodically output from the encoder of the head moving mechanism 30. On the basis of the ejection position data, the droplet ejecting nozzles 52 and the substrate W are disposed relative to each other, and the nozzles 52 eject droplets toward the substrate W.

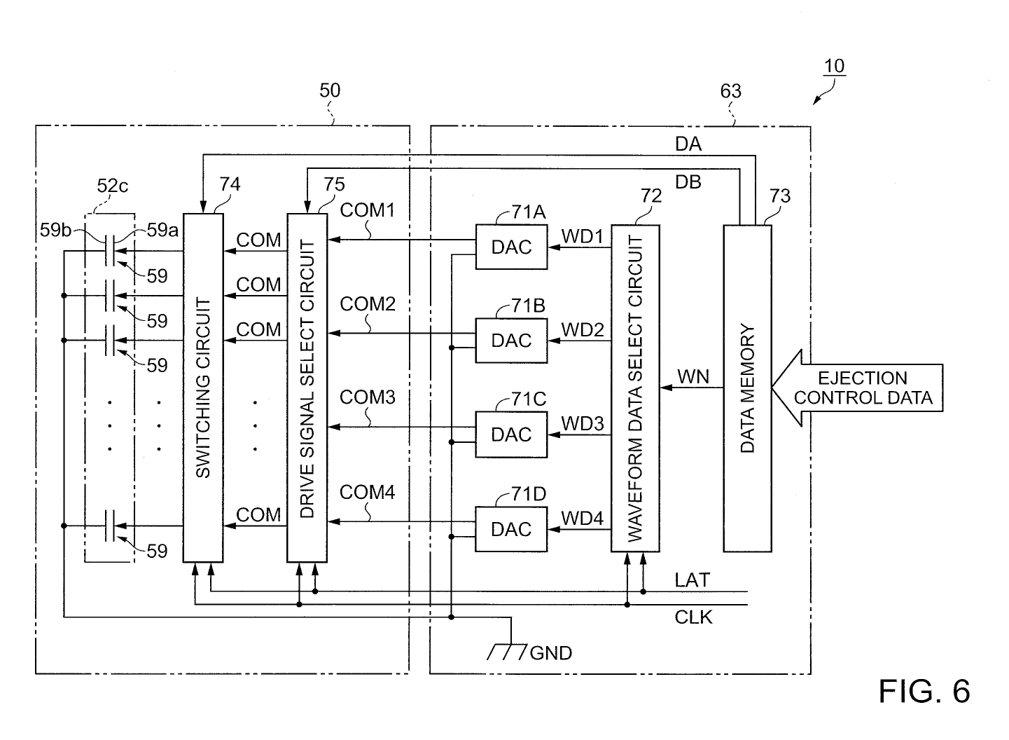

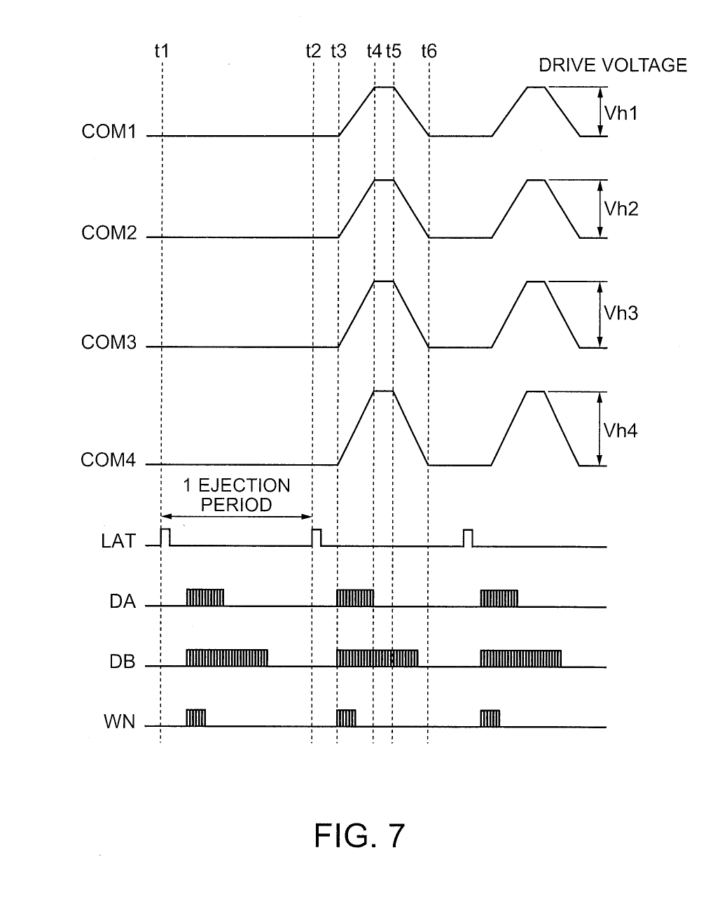

The embodiment below describes an ejection control method for the inkjet heads 50, specifically a drive control method for the piezoelectric element provided for each nozzle 52, with reference to FIGS. 6 and 7. FIG. 6 is a block diagram representing the electrical control of the inkjet head.

As represented in FIG. 6, the head driver 63 includes D/A converters (hereinafter, “DACs”) 71A to 71D that independently generate a plurality of different drive signals COM for controlling droplet ejection amounts, a waveform data select circuit 72 having a storage memory therein for slew rate data (hereinafter, “waveform data (WD1 to WD4)”) of drive signals COM generated by the DACs 71A to 71D, and a data memory 73 for storing the ejection control data sent from the host computer 11 via the P-CON 44. The drive signals COM generated in the DACs 71A to 71D are output to their respective COM lines for COM1 to COM4. The data memory 73 is an example of the first memory section that stores information of drive conditions for driving the drive elements in the droplet ejection apparatus according to the invention. Specifically, the ejection control data contains drive condition information.

The inkjet heads 50 are each provided with a switching circuit 74 for switching ON/OFF of drive signal COM application to the piezoelectric element 59 provided as the drive element (actuator) for each nozzle 52, and a drive signal select circuit 75 that selects any one of the COM lines, and sends the drive signal COM to the switching circuit 74 connected to each piezoelectric element 59.

In the nozzle line 52c (see FIG. 3), one of the electrodes, 59b, of the piezoelectric element 59 is connected to the ground line (GND) of the DACs 71A to 71D. The other electrode 59a (hereinafter, “segment electrode 59a”) of the piezoelectric element 59 is electrically connected to the COM line via the switching circuit 74 and the drive signal select circuit 75. The switching circuit 74, the drive signal select circuit 75, and the waveform data select circuit 72 are adapted to receive a clock signal (CLK), and a latch signal (LAT) corresponding to each ejection timing.

The data memory 73 stores data for each ejection timing that is periodically set according to the scan position of each inkjet head 50. Specifically, the data memory 73 stores at least ejection data DA that specifies application (ON/OFF) of drive signals COM to the piezoelectric elements 59, drive signal select data DB that specifies selection of COM lines (COM1 to COM4) corresponding to the piezoelectric elements 59, and waveform number data WN that specifies the type of waveform data (WD1 to WD4) input to the DACs 71A to 71D. In the present embodiment, the ejection data DA is configured as 1-bit (0, 1) data per nozzle, the drive signal select data DB is configured as 2-bit (0, 1, 2, 3) data per nozzle, and the waveform number data WN is configured as 7-bit (0 to 127) data per DAC. The data structure may be appropriately changed.

FIG. 7 is a timing chart of drive signals and control signals. In the foregoing configuration, the drive control related to each ejection timing point is performed as follows. As shown in FIG. 7, in timing periods t1 to t2, the ejection data DA, the drive signal select data DB, and the waveform number data WN are sent to the switching circuit 74, the drive signal select circuit 75, and the waveform data select circuit 72, respectively, after being converted into serial signals. At timing t2, each data is latched, and the segment electrode 59a of the piezoelectric element 59 related to ejection (ON) is brought to a state that connects the segment electrode 59a to the COM line (any of COM1 to COM4) designated by the drive signal select data DB. For example, when the drive signal select data DB is “0”, the segment electrode 59a of the piezoelectric element 59 is connected to COM1. Similarly, the segment electrode 59a of the piezoelectric element 59 is connected to COM2, COM3, and COM 4 when the drive signal select data DB is “1”, “2”, and “3”, respectively. The drive signal waveform data (WD1 to WD4) related to generation of DACs 71A to 71D are set in tandem with the foregoing selection.

In timing periods t3 to t4, the drive signal COM is generated in a series of steps involving potential increase, potential hold, and potential drop according to the waveform data set at timing t2. The drive signal COM so generated is supplied to the piezoelectric elements 59 being connected to COM1 to COM4, and the volume (pressure) of the cavity in communication with the nozzle 52 is controlled.

The time component and the voltage component related to potential increase, potential hold, and potential drop in the drive signal COM are closely dependent on the ejection amount of the liquid (ink) ejected in response to the supplied signal. Particularly, because the ejection amount shows desirable linearity with voltage component changes in the piezoelectric inkjet heads 50, a change (potential difference) in the voltage component at timing points t3 to t4 can be specified as drive voltage Vh (Vh1 to Vh4), and used as an ejection amount control condition. Specifically, the drive voltage Vh is one of the drive signal conditions for controlling the droplet ejection amount. The generated drive signal COM is not limited to the simple trapezoidal wave exemplified in the present embodiment, and waveforms of various known shapes, for example, a rectangular wave, may be appropriately used. In an embodiment involving a different drive mode (for example, a thermal mode), the pulse width (time component) of the drive signal COM may be used as an ejection amount control condition.

In the present embodiment, a plurality of waveform data with stepped, differing drive voltages Vh may be prepared, and independent waveform data (WD1 to WD4) may be input to the DACs 71A to 71D to output drive signals COM of different drive voltages Vh1 to Vh4 to the COM lines. A total of 128 waveform data may be prepared that correspond to the amount of information (7 bits) of the waveform number data WN, and these data are associated with drive voltages Vh that differ from each other, for example, in a 0.1 V step. In other words, the drive voltages Vh1 to Vh4 may have a drive waveform that is set in a 0.1 V step in a potential difference range of 12.8 V.

By taking into consideration the ejection characteristics of each nozzle 52, the droplet ejection apparatus 10 of the present embodiment can thus eject the liquid (ink) with the adjusted droplet ejection amount, using the drive signal select data DB, which is appropriately set to specify the correspondence between the piezoelectric elements 59 (nozzles 52) and the COM lines, and the waveform number data WN, which is appropriately set to specify the correspondence between the COM lines and the types of drive signals COM (drive voltages Vh). In other words, it can be said that appropriately setting the drive signal COM of each nozzle 52, which is determined by the relationship between the drive signal select data DB and the waveform number data WN, is important for the management of ejection amount.

In the droplet ejection apparatus 10, the ejection control method of the inkjet heads 50 can update the drive signal select data DB and the waveform number data WN for each ejection of a droplet, or each ejection timing. It is also possible to finely set the drive signal COM by associating it with the ejection data DA. Because the ejection amount of the droplet ejected through each nozzle 52 can be varied in at least 4 levels in every ejection timing, the variation of droplet ejection amount due to the ejection characteristics of the nozzle line 52c can be adjusted for each nozzle 52 in every ejection of a droplet, as opposed to when a certain drive signal COM is applied to each piezoelectric element 59.

On the other hand, despite that the ejection amount of the droplet ejected through each nozzle 52 can be varied in at least 4 levels in every ejection of a droplet, it is still difficult to achieve a constant ejection amount, for example, a reference ejection amount (or a target ejection amount) for all the nozzles 52. This is for a mechanical reason that, for example, the structure of the cavity in communication with the nozzle 52 is not necessarily the same for all nozzles 52, and for an electrical reason that the electrical characteristics of the piezoelectric element 59 are not necessarily the same for all nozzles 52. The droplet ejection method of the present embodiment is concerned with correction of the total liquid ejection amount, intended to reduce the influence of the droplet ejection amount variation across the nozzles 52 on a predetermined amount of liquid when a predetermined amount of liquid is ejected in the form of a plurality of droplets to a placement region of the substrate W through the nozzles 52 of the inkjet head 50.

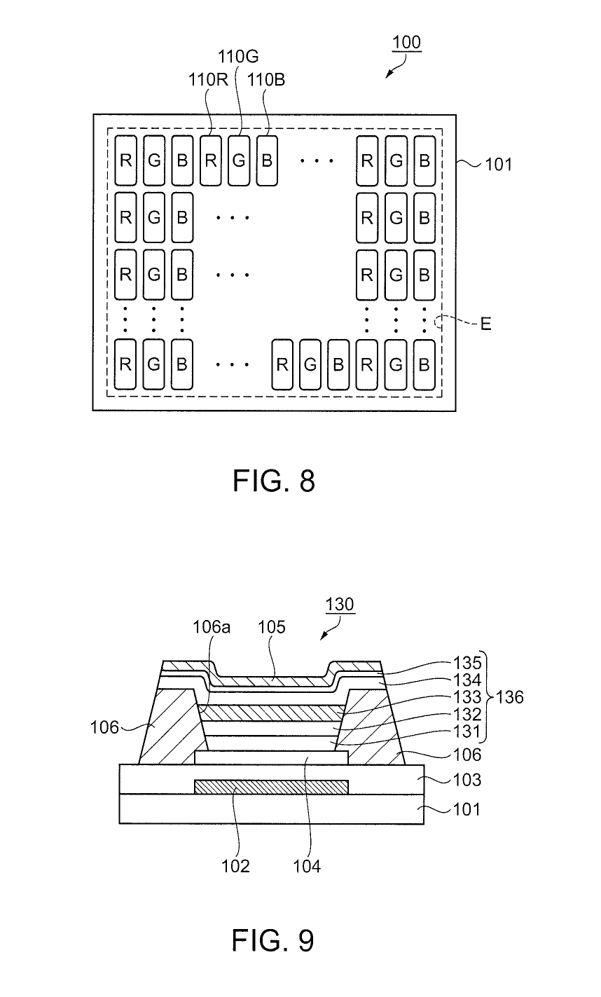

Before describing the droplet ejection method of the present embodiment, the following describes an organic electroluminescence (EL) apparatus as an example of an electrooptical apparatus to which the droplet ejection method of the present embodiment is applied, with reference to FIGS. 8 and 9. FIG. 8 is a schematic plan view illustrating a configuration of the organic EL device. FIG. 9 is a schematic cross sectional view illustrating a configuration of the organic EL element.

### Organic EL Device

As illustrated in FIG. 8, the organic EL device 100 as an example of an electrooptical apparatus includes a device substrate 101 on which sub pixels 110R, 110G, and 110B for producing red (R), green (G), and blue (B) emission (emission colors) are disposed. The sub pixels 110R, 110G, and 110B are substantially rectangular in shape, and are disposed in a matrix in a display region E of the device substrate 101. In the following, the sub pixels 110R, 110G, and 110B are also called collectively as sub pixels 110. The sub pixels 110 of the same emission color are arranged in the vertical direction of the figure (a column direction, or a longitudinal direction of sub pixels 110), whereas the sub pixels 110 of different emission colors are arranged in the horizontal direction of the figure (a row direction, or a shorter direction of sub pixels 110) in order of R, G, and B. Specifically, the sub pixels 110R, 110G, and 110B of different colors are disposed in what is called a stripe mode. The planar shape, and the arrangement of the sub pixels 110R, 110G, and 110B are not limited to this. As used herein, “substantially rectangular” is inclusive of not only squares and rectangles, but quadrangles with round corners, and quadrangles in which the opposing sides are arc-shaped.

The sub pixels 110R have an organic EL element that produces red (R) emission. Likewise, the sub pixels 110G has an organic EL element that produces green (G) emission, and the sub pixels 110B has an organic EL element that produces blue (B) emission.

In the organic EL device 100, the sub pixels 110R, 110G, and 110B are electrically controlled in display pixel units of three sub pixels 110R, 110G, and 110B of different emission colors. This enables full-color display.

The sub pixels 110R, 110G, and 110B each has an organic EL element 130, as shown in FIG. 9. The organic EL element 130 includes a reflecting layer 102 provided on the device substrate 101, an insulating film 103, a pixel electrode 104, a counter electrode 105, and a functional layer 136 provided between the pixel electrode 104 and the counter electrode 105 and including a light-emitting layer 133.

The pixel electrode 104 functions as the anode. The pixel electrode 104 is provided for each of the sub pixels 110R, 110G, and 110B, and is formed using for example, a transparent conductive film such as ITO (Indium Tin Oxide).

The reflecting layer 102 provided underneath the pixel electrode 104 reflects the emitted light from the functional layer 136 back toward the pixel electrode 104 after the light has passed through the pixel electrode 104 having light transmissivity. The reflecting layer 102 is formed using materials, for example, such as aluminum (Al), silver (Ag), or other such metals having light reflectivity, and alloys of such metals. Accordingly, the insulating film 103 is provided over the reflecting layer 102 to prevent electrical shorting between the reflecting layer 102 and the pixel electrode 104. The insulating film 103 is formed using materials, for example, such as silicon oxide or silicon nitride, and silicon oxynitride.

The functional layer 136 is a layer in which a hole injection layer 131, a hole transport layer 132, a light-emitting layer 133, an electron transport layer 134, and an electron injection layer 135 are laminated in order from the pixel electrode 104 side. The light-emitting layer 133, in particular, is formed using materials that are selected according to the emission color. However, the term light-emitting layer 133 as used herein is a collective term that refers to any emission color. The configuration of the functional layer 136 is not limited to this, and the functional layer 136 may include other layers, such as an interlayer for controlling movement of carriers (holes and electrons).

The counter electrode 105 functions as the cathode. The counter electrode 105 is provided as a common electrode for the sub pixels 110R, 110G, and 110B, and is formed using materials, for example, such as an alloy of Al (aluminum) or Ag (silver) with Mg (magnesium).

Carrier holes are injected into the light-emitting layer 133 from the side of the pixel electrode 104 serving as anode, whereas carrier electrons are injected into the light-emitting layer 133 from the side of the counter electrode 105 serving as cathode. The injected holes and electrons in the light-emitting layer 133 form excitons (a state in which holes and electrons are bound to each other under the Coulomb's force), and a part of the energy is released as fluorescence or phosphorescence as the excitons become quenched (upon recombination of holes and electrons).

In the configuration of the organic EL device 100 provided with the reflecting layer 102, the emission from the light-emitting layer 133 can be extracted from the counter electrode 105 side when the counter electrode 105 is configured to be light transmissive. Such an emission mode is called the top-emission mode. Alternatively, when configured to make the counter electrode 105 light reflective without providing the reflecting layer 102, the organic EL device 100 may operate as bottom emission where the emission from the light-emitting layer 133 is extracted from the device substrate 101 side. The embodiment below will be described through the case where the organic EL device 100 is top emission. The organic EL device 100 of the present embodiment is an active-drive light-emitting device in which a pixel circuit capable of independently driving the organic EL elements 130 of the sub pixels 110R, 110G, and 110B is provided on the device substrate 101. The pixel circuit may have a known configuration, and is not illustrated in FIG. 9.

In the present embodiment, the organic EL device 100 has barrier ribs 106 overlapping the outer periphery of the pixel electrode 104 of each sub pixel 110R, 110G, and 110B in the organic EL element 130, and constituting an aperture 106a on the pixel electrode 104.

In the present embodiment, the functional layer 136 of the organic EL element 130 is a layer in which at least one of the hole injection layer 131, the hole transport layer 132, and the light-emitting layer 133 constituting the functional layer 136 is formed by a liquid phase process. The liquid phase process is a process whereby a liquid containing the constituent components of each layer and a solvent is applied to the aperture 106a surrounded by the barrier ribs 106, and dried to form the layer. In order to form the layer in a desired thickness, it is required to accurately apply a predetermined amount of the liquid to the aperture 106a. In the present embodiment, the liquid is ejected to the aperture 106a through the nozzle 52 of the inkjet head 50, using the droplet ejection apparatus 10. In the following, the liquid containing the constituent material of the functional layer and a solvent will be called ink. The aperture 106a surrounded by the barrier ribs 106 corresponds to the droplet placement region according to the invention.

In the organic EL device 100, any uneven emission in the sub pixels 110R, 110G, and 110B easily becomes noticeable, particularly when the organic EL device 100 is top emission. It is therefore preferable that the layers constituting the functional layer 136 have a flat cross sectional shape. In the present embodiment, a predetermined amount of ink is evenly applied to the aperture 106a, and dried to make the cross sectional shape of each layer flat. The ink is adjusted to confine parameters such as droplet ejection amount, ejection rate, and droplet length within predetermined ranges, taking into account the ejection stability of the ink ejected as a droplet through the nozzle 52 of the inkjet head 50.

### Method of Production of Organic EL Element

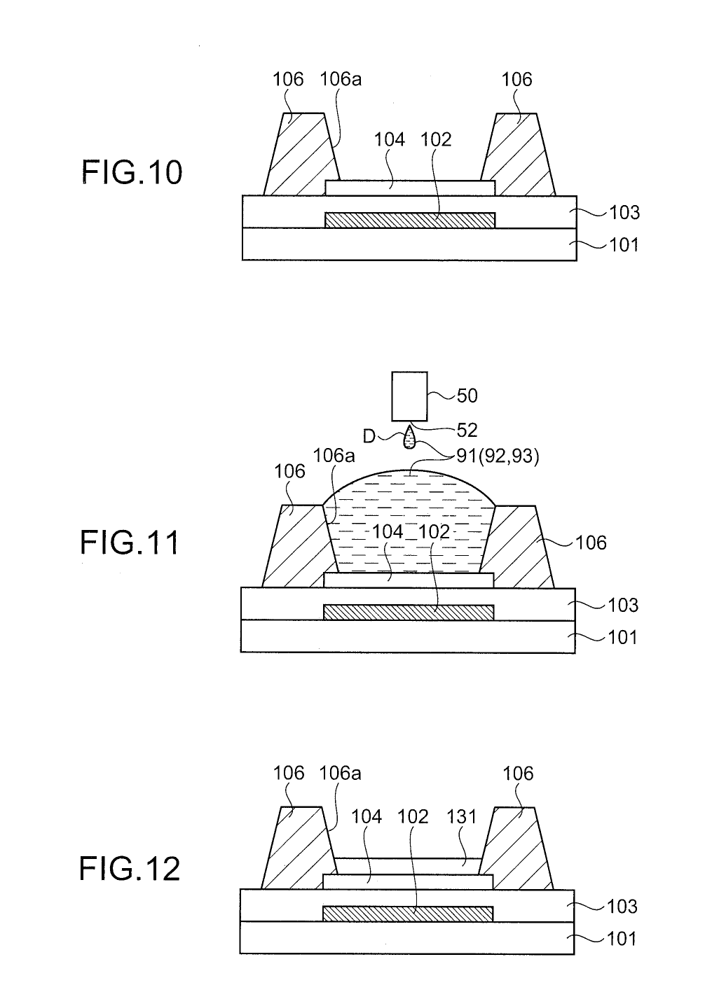

An organic EL element producing method is described below in detail, with reference to FIGS. 10 to 12. FIGS. 10 to 12 are schematic cross sectional views representing an organic EL element producing method. As noted above, the pixel circuit for driving and controlling the organic EL element 130, and the reflecting layer 102 and the pixel electrode 104 can be formed by using known methods. As such, the following will describe the subsequent steps, starting from the barrier ribs forming step.

A method for producing the organic EL element 130 of the present embodiment includes a barrier ribs forming step, a surface treatment step, a functional layer forming step, and a counter electrode forming step.

In the barrier rib forming step, as shown in FIG. 10, a photosensitive resin material containing, for example, a liquid repellent material having liquid repellency against the ink is applied in a thickness of 1 μm to 2 μm to the device substrate 101 on which the reflecting layer 102 and the pixel electrode 104 have been formed, and is dried to form a photosensitive resin layer. The photosensitive resin material may be applied using, for example, a transfer method, or slit coating. Examples of the liquid repellent material include fluorine compounds, and siloxane-based compounds. Examples of the photosensitive resin material include negative-type multifunctional acrylic resins. The photosensitive resin layer so formed is exposed and developed through an exposure mask corresponding to the shape of the sub pixel 110 to form the barrier ribs 106 overlapping the outer periphery of the pixel electrode 104, and constituting the aperture 106a on the pixel electrode 104. The sequence then goes to the surface treatment step.

In the surface treatment step, the device substrate 101 with the barrier ribs 106 is subjected to a surface treatment. The surface treatment step is performed for the purpose of removing unwanted materials such as the barrier rib residues on the surface of the pixel electrode 104 so that the ink containing the functional layer forming materials (solid components) can evenly wet the surface and spread in the aperture 106a surrounded by the barrier ribs 106 when the hole injection layer 131, the hole transport layer 132, and the light-emitting layer 133 constituting the functional layer 136 are formed by using an inkjet method (droplet ejection method) in the next step. In the present embodiment, the surface treatment is performed by an excimer UV (ultraviolet) process. The surface treatment is not limited to the excimer UV process, as long as it can clean the surface of the pixel electrode 104. For example, the surface treatment may be performed by washing and drying using a solvent. The surface treatment step may be omitted when the surface of the pixel electrode 104 is clean. In the present embodiment, the barrier ribs 106 are formed using a photosensitive resin material containing a liquid repellent material. However, the method is not limited to this, and the surface treatment may be performed by using the following procedure. A photosensitive resin material that does not contain a liquid repellent material is used to form the barrier ribs 106, and the surfaces of the barrier ribs 106 are rendered liquid repellent by, for example, a plasma treatment performed in the surface treatment step using a fluorine-based processing gas. The surface of the pixel electrode 104 is then rendered lyophilic in a plasma treatment performed by using oxygen as a processing gas. The sequence then goes to the functional layer forming step.

The functional layer forming step begins with application of a hole injection layer forming material-containing ink 91 to the aperture 106a, as shown in FIG. 11. The ink 91 is applied by being ejected as a droplet D to the aperture 106a through the nozzle 52 of the inkjet head 50, using the droplet ejection apparatus 10. The ejection amount of the droplet D ejected through the inkjet head 50 is controllable in units of pl (picoliters), and the droplet D is ejected to the aperture 106a in numbers obtained after the predetermined amount is divided by the ejection amount of droplet D. The ink 91 ejected becomes convex in the aperture 106a because of the interface tension with the barrier ribs 106, but does not flow out of the aperture 106a. In other words, the concentration of the hole injection layer forming material in the ink 91 is preadjusted to make a predetermined amount that does not cause the ink 91 to flow out of the aperture 106a. The sequence then goes to the drying step.

In the drying step, for example, the device substrate 101 after the application of the ink 91 is left unattended under reduced pressure to evaporate the solvent and dry the ink 91 (reduced pressure drying step). This is followed by burning, which involves heating, for example, at 180° C. for 30 minutes under atmospheric pressure to solidify the dried liquid, and form the hole injection layer 131, as shown in FIG. 12. The hole injection layer 131 is formed in a thickness of about 10 nm to 30 nm, though the thickness is not necessarily limited to this, and may vary with the selection of the hole injection layer forming material (described later), and the relationship with the other layers of the functional layer 136.

Thereafter, the hole transport layer 132 is formed using an ink 92 containing hole transport layer forming materials. The hole transport layer 132 is formed using the droplet ejection apparatus 10, as with the case of the hole injection layer 131. Specifically, a predetermined amount of ink 92 is ejected as a droplet D to the aperture 106a through the nozzle 52 of the inkjet head 50. The ink 92 applied to the aperture 106a is then dried under reduced pressure. This is followed by burning, which involves heating, for example, at 180° C. for 30 minutes in an inert gas environment, such as in nitrogen, to form the hole transport layer 132. The hole transport layer 132 is formed in a thickness of about 10 nm to 20 nm, though the thickness is not necessarily limited to this, and may vary with the selection of the hole transport material (described later), and the relationship with the other layers of the functional layer 136. The hole injection layer 131 and the hole transport layer 132 may be combined as a hole injection/transport layer as allowed by the relationship with the other layers of the functional layer 136.

Thereafter, the light-emitting layer 133 is formed using an ink 93 containing light-emitting layer forming materials. The light-emitting layer 133 is formed using the droplet ejection apparatus 10, as with the case of the hole injection layer 131. Specifically, a predetermined amount of ink 93 is ejected as a droplet D to the aperture 106a through the nozzle 52 of the inkjet head 50. The ink 93 applied to the aperture 106a is then dried under reduced pressure. This is followed by burning, which involves heating, for example, at 130° C. for 30 minutes in an inert gas environment, such as in nitrogen, to form the light-emitting layer 133. The light-emitting layer 133 is formed in a thickness of about 60 nm to 80 nm, though the thickness is not necessarily limited to this, and may vary with the selection of the light-emitting layer forming material (described later), and the relationship with the other layers of the functional layer 136.

Thereafter, the electron transport layer 134 is formed over the light-emitting layer 133. The electron transport material constituting the electron transport layer 134 is not particularly limited. Examples of electron transport materials that can be used to form the layer in a gas phase process such as a vacuum vapor deposition method include BALq, 1,3,5-tri(5-(4-tert-butylphenyl)-1,3,4-oxadiazole) (OXD-1), BCP (bathocuproine), 2-(4-biphenyl)-5-(4-tert-butylphenyl)-1,2,4-oxadiazole (PBD), 3-(4-biphenyl)-5-(4-tert-butylphenyl)-1,2,4-triazole (TAZ), 4,4′-bis(1,1-bisdiphenylethenyl)biphenyl (DPVBi), 2,5-bis(1-naphthyl)-1,3,4-oxadiazole (BND), 4,4′-bis(1,1-bis(4-methylphenyl)ethenyl)biphenyl (DTVBi), and 2,5-bis(4-biphenylyl)-1,3,4-oxadiazole (BBD).

Other examples include tris(8-quinolinato)aluminum (Alq₃), oxadiazole derivatives, oxazole derivatives, phenanthroline derivatives, anthraquinodimethane derivatives, benzoquinone derivatives, naththoquinone derivatives, anthraquinone derivatives, tetracyanoanthraquinodimethane derivatives, fluorene derivatives, diphenyldicyanoethylene derivatives, diphenoquinone derivatives, and hydroxyquinoline derivatives. These may be used alone or in a combination of two or more.

The electron transport layer 134 is formed in a thickness of about 20 nm to 40 nm, though the thickness is not necessarily limited to this, and may vary with the selection of the electron transport material, and the relationship with the other layers of the functional layer 136. In this way, the electrons injected from the cathode counter electrode 105 can be desirably transported to the light-emitting layer 133. The electron transport layer 134 may be omitted as may be allowed by the relationship with the other layers of the functional layer 136.

Thereafter, the electron injection layer 135 is formed over the electron transport layer 134. The electron injection materials constituting the electron injection layer 135 are not particularly limited. Examples of electron injection materials that can be used to form the layer in a gas phase process such as a vacuum vapor deposition method include alkali metal compounds, and alkali earth metal compounds.

Examples of the alkali metal compounds include alkali metal salts such as LiF, Li₂CO₃, LiC1, NaF, Na₂CO₃, NaCl, CsF, Cs₂CO₃, and CsCl. Examples of the alkali earth metal compounds include alkali-earth metal salts such as CaF₂, CaCO₃, SrF₂, SrCO₃, BaF₂, and BaCO₃. These alkali metal compounds and alkali earth metal compounds may be used alone or in a combination of two or more.

The thickness of the electron injection layer 135 is not particularly limited, and is preferably about 0.01 nm to 10 nm, more preferably about 0.1 nm to 5 nm. In this way, electrons can be efficiently injected into the electron transport layer 134 from the cathode counter electrode 105.

In the counter electrode forming step, the counter electrode 105 is formed as cathode over the electron injection layer 135. The constituent material of the counter electrode 105 is preferably a material with a small work function that can be used to form the electrode in a gas phase process such as a vacuum vapor deposition method. Examples of such materials include Li, Mg, Ca, Sr, La, Ce, Er, Eu, Sc, Y, Yb, Ag, Cu, Al, Cs, Rb, Au, and alloys of these. These may be used alone or in a combination of two or more (for example, a multilayer laminate).

The constituent material of the counter electrode 105 is preferably a metal such as Mg, Al, Ag, and Au, or an alloy such as MgAg, MgAl, MgAu, and AlAg, particularly when the organic EL device 100 is top emission as in the present embodiment. By using these metals or alloys, the electron injection efficiency and the stability of the counter electrode 105 can be improved while maintaining the light transmissivity of the counter electrode 105.

The thickness of the counter electrode 105 in a top emission mode is not particularly limited, and is preferably about 1 nm to 50 nm, more preferably about 5 nm to 20 nm.

The counter electrode 105 is not required to be light transmissive when the organic EL device 100 is bottom emission. In this case, metals such as Al and Ag, and alloys such as AlAg and AlNd are preferably used. By using such metals or alloys as the constituent material of the counter electrode 105, the electron injection efficiency and the stability of the counter electrode 105 can be improved.

The thickness of the counter electrode 105 in a bottom-emission mode is not particularly limited, and is preferably about 50 nm to 1,000 nm, more preferably about 100 nm to 500 nm.

Referring to FIG. 9, in the organic EL element 130 produced by using the method described above, the light-emitting function of the functional layer 136 becomes inhibited, and causes a partial drop in emission luminance, or produces non-emitting dark spots in the functional layer 136, for example, upon entry of external moisture or oxygen. There is also a risk of a reduced emission lifetime. It is therefore preferable to cover the organic EL element 130 with a sealing layer (not illustrated) to protect the organic EL element 130 from moisture and oxygen. The sealing layer may be, for example, an inorganic insulating material, such as silicon oxynitride (SiON), having low moisture and oxygen transmissivity. Alternatively, a sealing substrate, for example, such as transparent glass, may be attached via an adhesive to the device substrate 101 after the formation of the organic EL element 130 to seal the organic EL element 130.

In the method for producing the organic EL element 130 described above, a liquid phase process (inkjet method) is used to form the hole injection layer 131, the hole transport layer 132, and the light-emitting layer 133 of the functional layer 136. However, only one of these layers may be formed by using a liquid phase process (inkjet method), and the other layers may be formed by using a gas phase process such as vacuum vapor deposition.

The droplet ejection method of the present embodiment is described below in detail, using the formation method of the hole injection layer 131 in the method of production of the organic EL element 130 as an example.

### Droplet Ejection Method

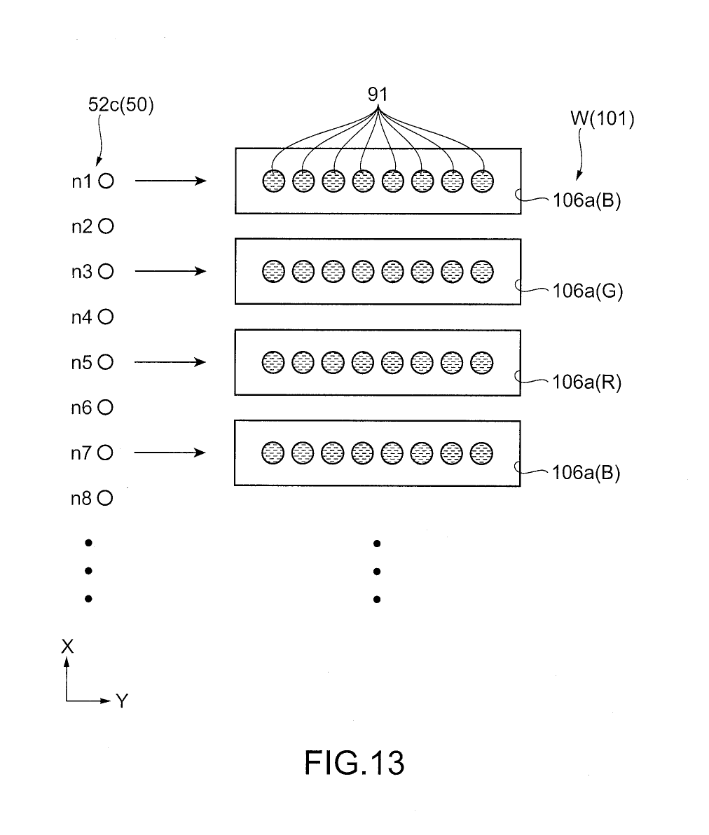

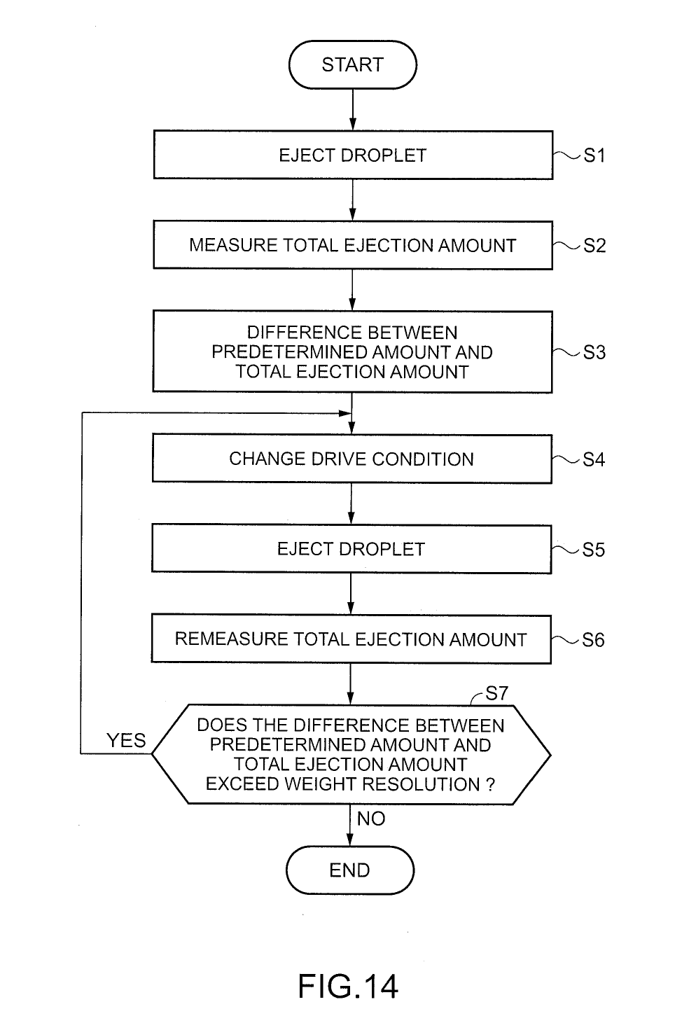

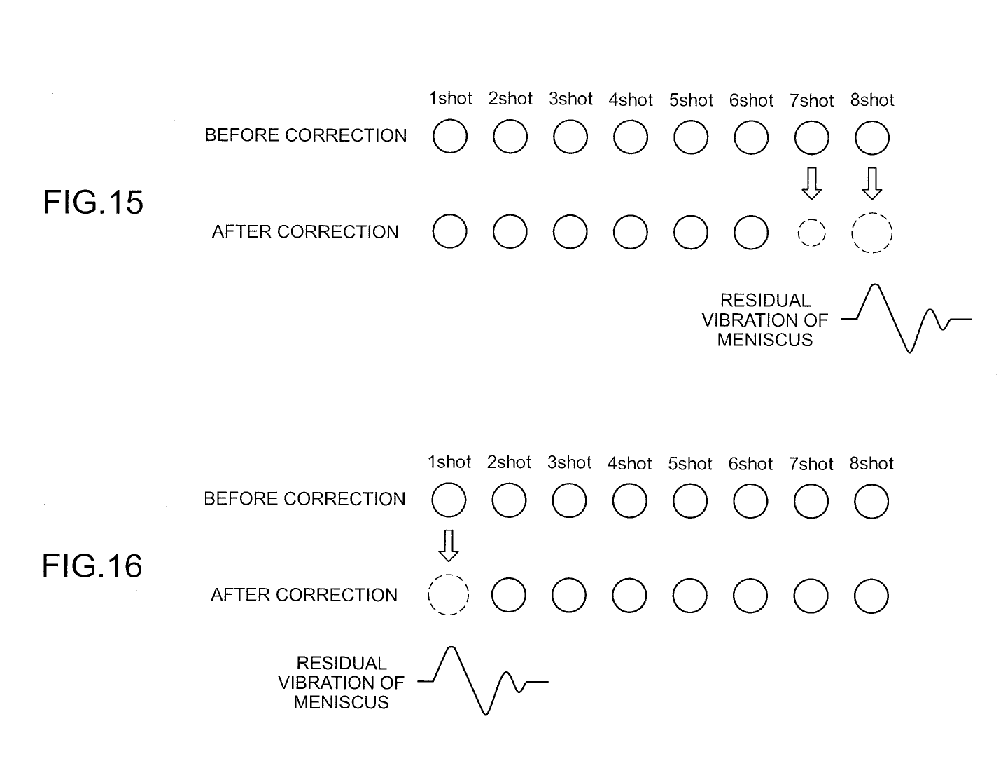

The droplet ejection method of the present embodiment is described below with reference to FIGS. 13 to 16. FIG. 13 is a schematic plan view representing an example of the placement of droplets in the aperture. FIG. 14 is a flowchart representing the droplet ejection method. FIG. 15 is a schematic plan view representing an example of ejections with a corrected ejection amount of droplet in multiple ejections. FIG. 16 is a schematic plan view representing another example of ejections with a corrected ejection amount of droplet in multiple ejections.

Before describing the droplet ejection method, an example of the placement of droplets in the aperture is described below with reference to FIG. 13. As described above, when an inkjet method is used to form the hole injection layer 131 in the functional layer 136 of the organic EL element 130, the substrate W as the ejection target device substrate 101 is mounted on the stage 5 of the droplet ejection apparatus 10. Here, as illustrated in FIG. 13, the nozzle line 52c of the inkjet head 50 is disposed in the sub scan direction (X-axis direction) that is orthogonal to the main scan direction (Y-axis direction). On the other hand, the aperture 106a, substantially rectangular in shape as viewed in planar view, is disposed with its longitudinal direction aligned with the main scan direction (Y-axis direction). In other words, the substrate W is mounted and located on the stage 5 in such a manner that the longitudinal direction of each aperture 106a as a droplet placement region where the organic EL elements 130 of the corresponding colors red (R), green (G), and blue (B) are formed is aligned with the main scan direction (Y-axis direction). Such an arrangement of apertures 106a relative to the nozzle line 52c is called longitudinal drawing. The arrangement of the nozzle line 52c in longitudinal drawing is not limited to the arrangement along X-axis direction, and the nozzle line 52c may be disposed with an angle with respect to X-axis direction. In this way, the nozzle pitch can be made narrower as viewed from Y-axis direction. In other words, the actual nozzle pitch can be adjusted by changing the way the nozzle line 52c is disposed, according to the pitch with which the apertures 106a are disposed in X-axis direction.

In a main scan where the inkjet head 50 and the substrate W are moved relative to each other in Y-axis direction, the ink 91 containing hole injection layer forming materials is placed in the aperture 106a by being ejected in the form of a plurality of droplets through one of the nozzles 52 covering the aperture 106a. The present embodiment describes an example in which, for example, eight droplets are ejected in the aperture 106a with intervals in Y-axis direction. Specifically, the ejection is performed 8 times, each ejecting and a single droplet is ejected in each ejection and land onto the aperture 106a. Note that FIG. 13 depicts the placement of a plurality of droplets in the aperture 106a, not the actual landed state of droplets. The droplets that have landed on the aperture 106a wet the aperture 106a, and spread over it and integrate before becoming convex as shown in FIG. 11. Here, the total ejection amount of the ink 91 ejected to each aperture 106a is the sum of the ejection amounts of the eight droplets. In order to form the hole injection layer 131 of the desired thickness, the total ejection amount of the ink 91 needs to be about the same as the predetermined amount, a design amount specified as the target total ejection amount.

As shown in FIG. 14, the droplet ejection method of the present embodiment (liquid total ejection amount correction method) is configured to include a droplet ejection step (step S1), a total ejection amount measuring step (step S2), a step of determining the difference between a predetermined amount and the total ejection amount (step S3), a step of changing a drive condition (step S4), a droplet ejection step (step S5), a total ejection amount remeasuring step (step S6), and a step of determining whether the difference between the predetermined amount and the total ejection amount exceeds a weight resolution (step S7). The following specifically describes the droplet ejection method of the present embodiment, on the assumption that the droplets in the aperture 106a are arranged as shown in FIG. 13.

In the droplet ejection step S1, ejection is performed 8 times under a preset drive condition to eject eight droplets through the nozzle 52. The preset drive condition in the present embodiment is a condition in which the drive signal COM shown in FIG. 7 has a constant drive voltage Vh for the eight ejections. For example, ejection is performed 8 times after the drive signal COM3 having a drive voltage Vh between Vh1 and Vh4 is selected from the drive signals COM1 to COM4. The total ejection amount measuring step S2 measures the total ejection amount of the ejected eight droplets. More specifically, the total ejection amount (weight) of the eight droplets is measured with the weight measuring mechanism 81 described above. In other words, it is not required to actually eject eight droplets to the aperture 106a, but the weight measuring mechanism 81 receives and measures the ejected droplets by assuming that these were actually ejected to the aperture 106a. In the next step S3, the difference between the predetermined amount (weight) of the ink 91 (liquid) given to the aperture 106a, and the measured total ejection amount (weight) is determined by calculations. In the next drive condition changing step S4, the drive condition of the nozzle 52 (piezoelectric element 59) for at least one of the eight ejections is changed so as to correct the difference between the predetermined amount and the total ejection amount determined in step S3.

In the drive condition changing step, the drive condition of at least one of the eight ejections is changed in a direction from the last (8th) ejection to the first ejection. In the example represented in FIG. 15, the drive condition is changed for the last (8th) ejection (shot 8), and the 7th ejection (shot 7). For example, for shot 8, the drive condition is changed so as to increase the droplet ejection amount by increasing the Vh value from the preset value of drive signal COM3. For shot 7, the drive condition is changed so as to decrease the droplet ejection amount by decreasing the Vh value from the preset value of drive signal COM3. In this manner, the drive condition is changed (corrected) with respect to the preset drive condition so that the total ejection amount of droplets in the eight ejections approaches the predetermined amount.

For example, in the drive condition changing step depicted in FIG. 16, the drive condition is changed to increase the droplet ejection amount by increasing the drive voltage Vh from the preset value of drive signal COM3 set for the first (shot 1) of the eight ejections. As a result of the change, the residual vibration in the meniscus of the liquid (ink) in the nozzle 52 under the new drive signal COM becomes different from the residual vibration of the meniscus before the change of the drive voltage Vh. The residual vibration of the meniscus in the first ejection (shot 1) may thus affect the second ejection (shot 2), and cause variation in the ejection amount compared to the droplet ejection amount of when the nozzle 52 (piezoelectric element 59) is driven solely with the preset drive signal COM3. In the droplet ejection method of the present embodiment, as depicted in the example of FIG. 15, the drive condition is changed in a direction from the last (8th) ejection to the first ejection to reduce the influence of the residual vibration of the meniscus due to the change of the drive voltage Vh of the drive signal COM. Particularly, a change that increases the drive voltage Vh tends to increase the residual vibration of the meniscus, and it is therefore preferable that the change be made in the drive condition of the last ejection. Specifically, it is preferable that a change that increases the drive voltage Vh be made in the last ejection so that the corrected value of the droplet ejection amount related to a change in the drive condition of the last ejection of multiple ejections become larger than the corrected value of the droplet ejection amount related to a change in the drive condition of any other ejection.

In the droplet ejection method of the present embodiment, a maximum correction amount is set as the maximum amount of droplet ejection amount that can be corrected by a change of the drive condition in a single ejection, and the drive condition is changed in two or more of multiple ejections (eight ejections) when the difference between the predetermined amount and the total ejection amount exceeds the maximum correction amount. An attempt to correct the difference between the predetermined amount and the total ejection amount in one ejection may result in an excessive load being applied to the piezoelectric element 59 (drive element) as a result of the change of the drive condition. Here, excessive load means that the piezoelectric element 59 is brought to an abnormally operating state as a result of the applied drive voltage Vh of the piezoelectric element 59 exceeding above the upper limit, or falling below the lower limit. In the example depicted in FIG. 15, the drive condition is separately changed in shot 8 and shot 7.

In the next droplet ejection step S5, eight droplets are ejected again in eight ejections by reflecting the change made in the drive condition in step S4. In the next total ejection amount remeasuring step S6, the weight measuring mechanism 81 remeasures the total ejection amount upon receiving the eight ejected droplets, as in step S2. In the next step S7, the difference between the predetermined amount and the remeasured total ejection amount is calculated, and whether the difference exceeds the weight resolution is determined. As used herein, “weight resolution” refers to the minimum variable amount of droplet ejection amount (weight) that can be varied by changing the drive condition. Steps S4 to S7 are repeated when the difference between the predetermined amount and the remeasured total ejection amount exceeds the weight resolution (YES). When the difference between the predetermined amount and the remeasured total ejection amount is smaller than the weight resolution (NO), the ejection amount correction of the droplet ejected through the nozzle 52 is finished. Specifically, step S4 to step S7 are repeated until the difference between the predetermined amount and the remeasured total ejection amount becomes smaller than the weight resolution. This is followed by the actual ejection step, in which the nozzle 52 (piezoelectric element) is driven under the currently changed drive condition to eject the ink 91 as a droplet to the aperture 106a from the nozzle 52. Note that the measurement resolution of the weight measuring mechanism 81 needs to be the same or smaller than the weight resolution.

In the droplet ejection method, steps S1 and S2 correspond to step A according to the invention, step S3 corresponds to step B according to the invention, step S4 corresponds to step C according to the invention, and steps S5 and S6 correspond to step D according to the invention. Step S7 includes step S3, specifically step B, and as such repeating steps S4 to S7 corresponds to step E according to the invention, and the actual ejection step corresponds to step F. The weight resolution corresponds to the correction resolution according to the invention. The correction resolution is not limited to the weight resolution, and may be, for example, a volume resolution based on a droplet volume, which can be determined by measuring the size of the landed droplet in the manner described above. The program that causes a computer to execute the droplet ejection method corresponds to the droplet ejection program according to the invention.

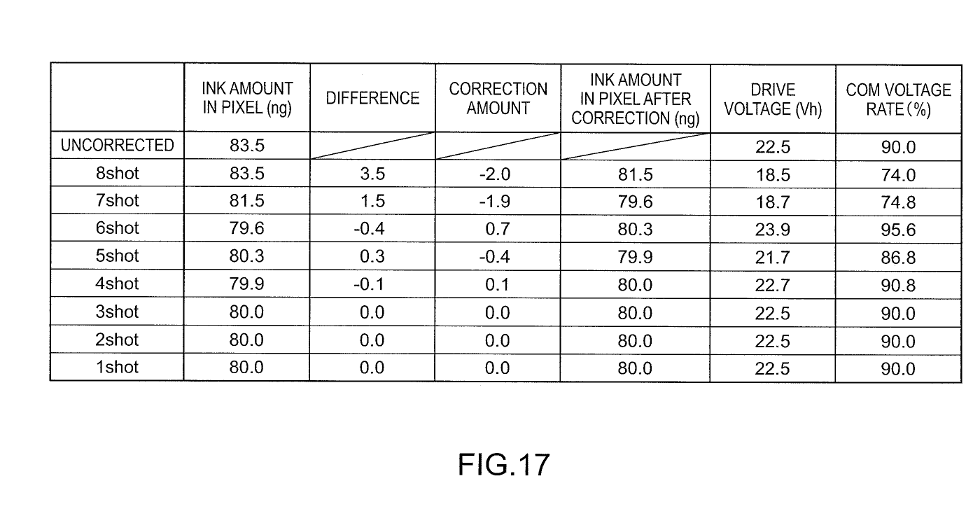

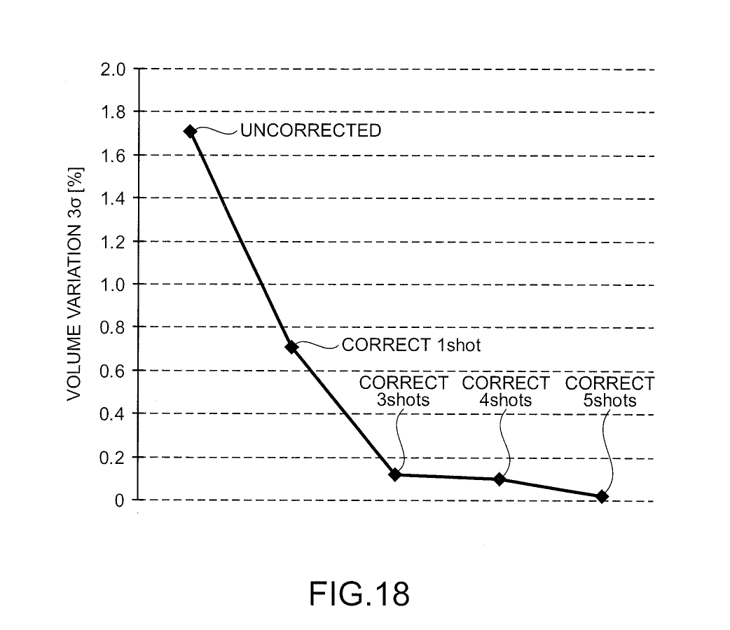

The effects of the droplet ejection method of the present embodiment are described below in greater detail referring to Examples. FIG. 17 is a table representing the correction of droplet ejection amounts, and the drive voltages of drive signals applied to the piezoelectric element according to Examples. FIG. 18 is a graph representing volume variation of the total ejection amount obtained after the correction of droplet ejection amounts according to Examples.

### EXAMPLES

In Examples, as illustrated in FIG. 13, the ink 91 (liquid) containing hole injection layer forming materials is ejected to the aperture 106a to place eight droplets. By design, this is intended to eject the ink 91 to the aperture 106a in a total predetermined amount of 80 ng, with each droplet being ejected in an amount of 10 ng. The ink 91 (liquid) was ejected in the form of eight droplets (step S1), and the total ejection amount was measured with the weight measuring mechanism 81 (step S2). Here, the drive voltage Vh for the drive signal COM was set to 22.5 V, 90% of the maximum drive voltage 25 V of the piezoelectric element 59 (a COM voltage rate of 900), as a preset drive condition for driving the nozzle 52, as shown in the table in FIG. 17. In an uncorrected state before the correction of a droplet ejection amount, the expected total ejection amount of the ink 91 to be ejected in the pixel, specifically the aperture 106a, was 83.5 ng. Specifically, the total ejection amount differed from the predetermined amount of 80 ng by 3.5 ng (step S3). In the drive condition changing step (step S4), the drive voltage Vh was decreased 4V from 22.5 V to 18.5 V so as to correct the droplet ejection amount by an amount of −2.0 ng in the last, 8th ejection (shot 8), basing on the linear correlation between drive voltage Vh and droplet ejection amount. Here, the maximum correction amount for the correction of a single droplet is set to be 2.0 ng. Specifically, because the ejection amount would be 3.5 ng larger than the predetermined amount under the preset drive condition, the ejection amount was negatively corrected by the largest amount in shot 8 (step S4). This was followed by ejection of eight droplets with the new drive condition (i.e., a drive condition after varying the drive voltage Vh only for the drive signal COM in shot 8, while using the preset drive signal COM3 for the other ejections) (step S5), and the total ejection amount was remeasured with the weight measuring mechanism 81 (step S6). The total ejection amount was 81.5 ng, as shown in the table in FIG. 17. The difference between the predetermined amount and the remeasured total ejection amount was 1.5 ng. The weight resolution in the present embodiment is 0.1 ng, and accordingly the difference exceeded the weight resolution (YES in step S7). The sequence from steps S4 to S7 is therefore repeated. Because the difference was 1.5 ng in step S7, the drive voltage Vh of the drive signal COM was decreased 3.8 V from 22.5 V to 18.7 V so as to correct the droplet ejection amount by −1.9 ng in shot 7. Eight droplets were ejected with the new drive condition after varying the drive voltage Vh for shot 8 and shot 7, and the total ejection amount was remeasured to be 79.6 ng, making a difference of −0.4 ng from the predetermined amount. This time, the drive voltage Vh of the drive signal COM was increased 1.4 V from 22.5 V to 23.9 V so as to correct the droplet ejection amount by +0.7 ng in shot 6. The total ejection amount was remeasured after ejecting eight droplets under the new drive condition with the varied drive voltages Vh for shots 8, 7, and 6. The total ejection amount was 80.3 ng, making a difference of 0.3 ng from the predetermined amount. The drive voltage Vh of the drive signal COM was then decreased 0.8 V from 22.5 V to 21.7V so as to correct the droplet ejection amount by −0.4 ng in shot 5. The total ejection amount was remeasured after ejecting eight droplets under the new drive condition with the varied drive voltages Vh for shots 8, 7, 6, and 5. The total ejection amount was 79.9 ng, making a difference of −0.1 ng from the predetermined amount. Because the absolute value of the difference between the total ejection amount and the predetermined amount was equal to the weight resolution, steps S4 to S7 were repeated, and the drive voltage Vh of the drive signal COM was increased 0.2 V from 22.5 V to 22.7 V so as to correct the droplet ejection amount by +0.1 ng in shot 4. The total ejection amount was remeasured after ejecting eight droplets under the new drive condition with the varied drive voltages Vh for shots 8, 7, 6, 5, and 4. The total ejection amount was 80 ng, making a difference of 0.0 ng from the predetermined amount. Because the absolute value of the difference became smaller than the weight resolution (NO in step S7), the correction of droplet ejection amount was finished.

The volume variation of the total ejection amount was measured in accord with the correction of the droplet ejection amounts for a total of five shots from shot 8 to shot 4 in the Example described above. As shown in FIG. 18, the volume variation also decreased after the corrections. The standard deviation 3σ of the volume variation was less than 0.2 after the correction of the three shots from the last shot to shot 6.

In the Example described above, the correction of droplet ejection amount was performed in 4 shots from the last shot 8 to shot 4. However, the correction of droplet ejection amount may be finished in the last shot when the difference between the total ejection amount of droplets and the predetermined amount is smaller than the maximum correction amount after the first measurement. Specifically, the correction may be finished without repeating steps S4 to S7.

The ejection of the liquid (ink) by the droplet ejection method is not limited to the application to the ink 91 containing hole injection layer forming materials, but is also applicable to the ink 92 containing hole transport layer forming materials, and to the ink 93 containing light-emitting layer forming materials.

The droplet ejection method of the embodiment, and the droplet ejection program for executing the droplet ejection method have the following effects.

(1) The drive condition is changed in at least one of multiple ejections so as to correct the difference between the total ejection amount of droplets ejected by driving the nozzle 52 under a preset drive condition, and the predetermined amount. Droplets are ejected under the new drive condition, and the difference between the total ejection amount of the droplets, and the predetermined amount is determined. The correction of droplet ejection amount, specifically, a change of drive condition is performed for the rest of the multiple ejections until the difference becomes smaller than the weight resolution for the correction of droplet ejection amount. In this way, the method, by knowing the total ejection amount of droplets, can correct the droplet ejection amount more easily than when correction is performed by determining the droplet ejection amount of each ejection (the drive condition of the nozzle 52 is changed for each ejection). When the droplet ejection amount is determined for each ejection, an error occurs in the accuracy of each measurement, and adds to a large value in multiple ejections. The invention, on the other hand, performs correction on the basis of the total ejection amount of droplets, and can achieve high correction accuracy. Specifically, by ejecting the liquid (ink) in the form of a droplet after the final change made to the drive condition, a predetermined amount of liquid (ink) can be stably ejected to the aperture 106a (placement region) in accurate quantities.

(2) A change made to the drive condition of the nozzle 52 in a single ejection for the correction of the difference between the total ejection amount of droplets and the predetermined amount is performed in a direction from the last to the first ejection in the multiple ejections. This makes it possible to reduce the influence of the first ejection on the second ejection after the drive condition is changed for the first ejection, as compared to when the droplet ejection amount is corrected (the drive condition of the nozzle 52 is changed) from the first ejection. Particularly, a change of drive condition that increases the drive voltage Vh has the risk of increasing the residual vibration in the meniscus of the liquid (ink) in the nozzle 52. Such an adverse effect of residual vibration in the meniscus can be avoided by performing the correction for the last ejection.

(3) By applying the droplet ejection program for executing the droplet ejection method of the embodiment to the droplet ejection apparatus 10, the time required for the correction of the total ejection amount of droplets can be reduced as compared to when the droplet ejection amount is measured for each ejection with the weight measuring mechanism 81, and a predetermined amount of droplets can be ejected in the placement region in the droplet ejection apparatus 10.

In the droplet ejection method of the embodiment described above, the weight measuring mechanism 81 measures the total ejection amount after the droplets were actually ejected. However, the invention is not limited to this embodiment. For example, the total ejection amount may be determined as follows. A relationship between droplet ejection amount and the drive voltage Vh of drive signal COM is determined beforehand. The nozzle 52 is driven under a preset drive condition to eject a plurality of droplets, and the drive condition is changed from the difference between the measured total ejection amount of the droplets and the predetermined amount according to the following procedure. The drive voltage Vh is varied as many times as required from the last ejection, using the predetermined relationship between droplet ejection amount and the drive voltage Vh of drive signal COM, and the total ejection amount of droplets under the new drive condition is determined by calculations, rather than by actual measurements. In this way, the time required for the correction of the total ejection amount of droplets can be reduced further.

The invention is not limited to the embodiments described above, and may be appropriately modified without departing from the gist or ideas of the invention as may be implied by the whole specification including the appended claims and the description, and a droplet ejection method and a droplet ejection program, and a droplet ejection apparatus to which the droplet ejection method is applicable involving such modifications are intended to fall within the technical scope of the invention. Aside from the foregoing embodiments, various variations are conceivable, for example, as follows.

### Variation 1

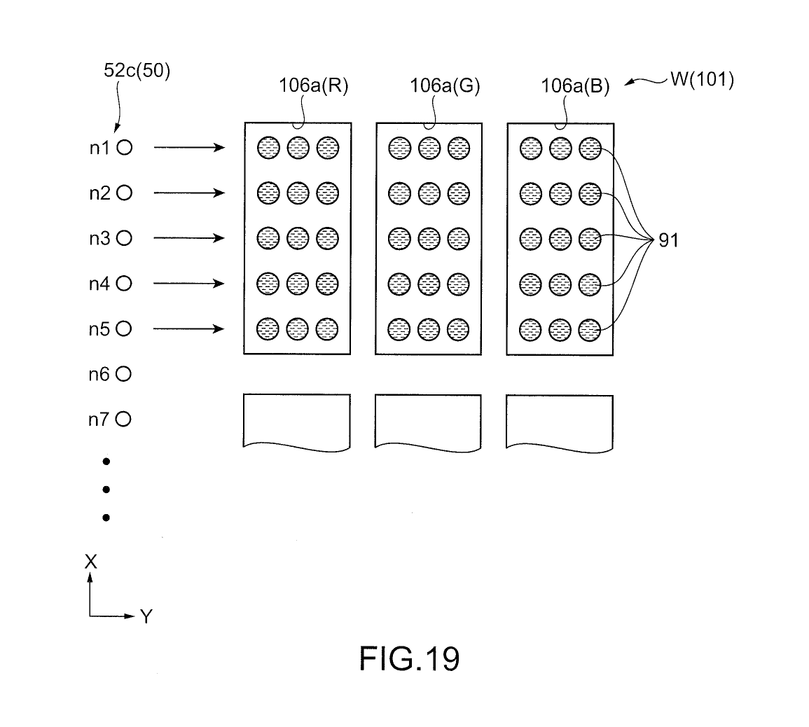

The placement (ejection) of a droplet in the placement region by the droplet ejection method of the embodiment described above is not limited to the longitudinal drawing in which droplets are ejected with the arrangement of the apertures 106a and the nozzle line 52c shown in FIG. 13. FIG. 19 is a schematic plan view representing a droplet ejection method of a variation.

As depicted in FIG. 19, the aperture 106a, substantially rectangular in shape in planar view, is disposed with its longitudinal direction and the shorter direction aligned along the sub scan direction (X-axis direction) and the main scan direction (Y-axis direction), respectively. On the other hand, the nozzle line 52c is disposed along the sub scan direction (X-axis direction), and accordingly a plurality of the nozzles 52 (five in the example of FIG. 19) covers the aperture 106a in a main scan. Such an arrangement of the apertures 106a and the nozzle line 52c is called horizontal drawing. By applying the droplet ejection method according to the invention, a predetermined amount of liquid (ink) can be stably ejected to the aperture 106a in accurate quantities even in the horizontal drawing in which a plurality of droplets (three droplets) is ejected from each of a plurality of nozzles 52 (five nozzles 52) covering the aperture 106a in a main scan. In the horizontal drawing, droplets are ejected to the aperture 106a through a plurality of nozzles 52 in a main scan, and ejections are affected by variation of droplet ejection amounts across the nozzles 52. This complicates the way droplet ejection amounts are corrected. On the other hand, in the longitudinal drawing described in the embodiment described above, only one nozzle 52 covers one aperture 106a in a main scan, and the effect of the droplet ejection method of this patent application is greater when the method is applied to longitudinal drawing than when applied to horizontal drawing.

### Variation 2

The method for forming a device to which the droplet ejection method of the embodiment is applied is not limited to the organic EL element 130 (or the organic EL device 100). For example, the method is also applicable to forming a color filter of a liquid crystal display device, and forming semiconductor layers of organic transistors, or interconnections connected to semiconductor layers.

The entire disclosure of Japanese Patent Application No. 2015-182622, filed Sep. 16, 2015 is expressly incorporated by reference herein.

What is claimed is:

1. A droplet ejection method in which an ejection head having a plurality of nozzles, and an ejection target are disposed face to face, and moved relative to each other for scanning, and in which a liquid is ejected multiple times in the form of a droplet through at least one of the plurality of nozzles to a placement region provided on the ejection target,
the method comprising:
step A driving the at least one nozzle under a preset drive condition, and determining the total ejection amount of the liquid of when performing the multiple ejections;
step B of determining the difference between the total ejection amount, and a predetermined amount of the liquid to be placed in the placement region;
step C of changing the drive condition for at least one of the multiple ejections so as to correct the difference between the predetermined amount of the liquid and the total ejection amount; and
step D of driving the at least one nozzle under the drive condition changed in the step C, and redetermining the total ejection amount of the liquid of when performing the multiple ejections.

2. The droplet ejection method according to claim 1, comprising step E of repeating the steps C, D, and B in this order until the difference between the predetermined amount of the liquid and the total ejection amount becomes smaller than a correction resolution for the correction of droplet ejection amount by a change of the drive condition.

3. The droplet ejection method according to claim 1,
wherein the method sets a maximum correction amount for the correction of droplet ejection amount by a change of the drive condition, and
wherein the method in the step C changes the drive condition for two or more of the multiple ejections when the difference between the predetermined amount of the liquid and the total ejection amount exceeds the maximum correction amount.

4. The droplet ejection method according to claim 1, wherein the method in the step C changes the drive condition in at least one of the multiple ejections in a direction from the last ejection to the first ejection.

5. The droplet ejection method according to claim 4, wherein the corrected value of the droplet ejection amount related to the change made in the step C to the drive condition of the last ejection of the multiple ejections is larger than the corrected value of the droplet ejection amount related to the change in the drive condition of any other ejection.

6. The droplet ejection method according to claim 1, wherein the method in the step A performs the multiple ejections by driving the at least one nozzle under a preset drive condition, and measures and determines the total ejection amount of the ejected liquid.

7. The droplet ejection method according to claim 1, wherein the method in the step D performs the multiple ejections by driving the at least one nozzle under the drive condition changed in the step C, and measures and determines the total ejection amount of the ejected liquid.

8. The droplet ejection method according to claim 1,
wherein the ejection head has a drive element for each of the plurality of nozzles, and varies the droplet ejection amount by varying a drive voltage applied to the drive element, and
wherein the method in the step D drives the at least one nozzle under the drive condition changed in the step C, using ejection amount information indicative of the relationship between the drive voltage of each drive element and droplet ejection amounts, and calculates and determines the total ejection amount of the liquid of when the multiple ejections are performed.

9. The droplet ejection method according to claim 1,
wherein the placement region provided on the ejection target is substantially rectangular in shape with the longitudinal direction extending in a scan direction, and
wherein the plurality of nozzles of the ejection head is arranged in a direction intersecting the scan direction.

10. A droplet ejection program for causing a computer to execute the droplet ejection method of claim 1, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

11. A droplet ejection program for causing a computer to execute the droplet ejection method of claim 2, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

12. A droplet ejection program for causing a computer to execute the droplet ejection method of claim 3, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

13. A droplet ejection program for causing a computer to execute the droplet ejection method of claim 4, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

14. A droplet ejection program for causing a computer to execute the droplet ejection method of claim 5, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

15. A droplet ejection program for causing a computer to execute the droplet ejection method of claim 6, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

16. A droplet ejection program for causing a computer to execute the droplet ejection method of claim 7, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

17. A droplet ejection program for causing a computer to execute the droplet ejection method of claim 8, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

18. A droplet ejection program for causing a computer to execute the droplet ejection method of claim 9, wherein an ejection head having a plurality of nozzles, and an ejection target are disposed face to face, and moved relative to each other for scanning, and wherein a liquid is ejected multiple times in the form of a droplet through at least one of the plurality of nozzles to a placement region provided on the ejection target.

19. A droplet ejection apparatus in which an ejection head having a plurality of nozzles, and an ejection target are disposed face to face, and moved relative to each other for scanning, and in which a predetermined amount of liquid is ejected multiple times in the form of a droplet through at least one of the plurality of nozzles to a placement region provided on the ejection target,
the droplet ejection apparatus comprising:
a stage on which the ejection target is mounted;
a moving mechanism for moving the stage in a first direction, relative to the ejection head;
a head driving section for driving a drive element provided for each of the plurality of nozzles of the ejection head;
an ejection amount measuring mechanism for measuring a total ejection amount of the liquid ejected through the ejection head;
a first memory section in which information of a drive condition for driving the drive element is stored;
a second memory section in which a measured value of the total ejection amount of the liquid is stored; and
a control section,
wherein the control section drives and controls the head driving section and the ejection amount measuring mechanism, and the moving mechanism so as to execute:
step A of performing the multiple ejections by driving the at least one nozzle under a drive condition prestored in the first memory section, and determine the total ejection amount of the ejected liquid with the ejection amount measuring mechanism;
step B of determining the difference between the predetermined amount of the liquid, and the total ejection amount;
step C of changing the drive condition for at least one of the multiple ejections so as to correct the difference between the predetermined amount of the liquid and the total ejection amount, and store the drive condition in the first memory section;
step D of driving the at least one nozzle under the drive condition changed, and redetermine the total ejection amount of the liquid of when performing the multiple ejections;
step E of repeating the steps C, D, and B in this order until the difference between the predetermined amount of the liquid and the total ejection amount becomes smaller than a correction resolution for the correction of droplet ejection amount by a change of the drive condition; and
step F of moving and scanning the ejection head and the ejection target in the first direction with the moving mechanism, and eject the liquid in the predetermined amount multiple times in the form of a droplet through at least one of the plurality of nozzles to the placement region provided on the ejection target, using the currently changed drive condition.

20. The droplet ejection apparatus according to claim 19,
wherein the placement region provided on the ejection target is substantially rectangular in shape, and the ejection target is mounted on the stage in such an orientation that the longitudinal direction of the placement region is aligned with the first direction, and
wherein the plurality of nozzles of the ejection head is arranged in a direction intersecting the first direction.
